(19) United States
(12) Patent Application Publication
(10) Pub. No.: US 2018/0357527 A1
(43) Pub. Date: Dec. 13, 2018

(54) DATA-PROCESSING DEVICE WITH REPRESENTATION OF VALUES BY TIME INTERVALS BETWEEN EVENTS

(71) Applicants: UNIVERSITE PIERRE ET MARIE CURIE (PARIS 6), Paris (FR); CENTRE NATIONAL DE LA RECHERCHE-SCIENTIFIQUE-CNRS-, Paris (FR); INSERM (INSTITUT NATIONAL DE LA SANTÉ ET DE LA RECHERCHE MÉDICALE), Paris (FR)

(72) Inventors: Ryad BENOSMAN, Pantin (FR); Xavier LAGORCE, Creteil (FR)

(21) Appl. No.: 15/743,642

(22) PCT Filed: Jul. 6, 2016
(86) PCT No.: PCT/FR2016/051717

§ 371 Date: Jan. 10, 2018

(30) Foreign Application Priority Data
Jul. 13, 2015 (FR) 1556659

(51) Int. Cl. G06N 3/04; G06F 17/13

(52) U.S. Cl. CPC G06N 3/049; G06F 17/13; G06N 3/0481

(57) ABSTRACT

The device for processing data comprises a set of processing nodes and connections between the nodes. Each connection is configured to transmit, to a receiver node, events delivered by an emitter node. Each node is arranged to vary a respective potential value according to events that it receives and to deliver an event when the potential value reaches a predefined threshold. At least one input value of the data processing device is represented by a time interval between two events received by at least one node, and at least one output value of the data processing device is represented by a time interval between two events delivered by at least one node.

### BACKGROUND

### Technical Field

The present invention relates to data processing techniques. Embodiments implement a new way of carrying out calculations in machines, in particular in programmable machines.

### Description of the Related Art

For the most part, current computers are based on the Von Neumann architecture. The data and the program instructions are stored in a memory that is accessed sequentially by an arithmetic logic unit in order to execute the program on the data. This sequential architecture is relatively inefficient, namely because of the requirement for numerous memory accesses, both for reading and writing.

The search for alternatives that are more energy-efficient lead to the proposition of clockless processing architectures that attempt to imitate the operation of the brain. Recent projects, such as the DARPA SyNAPSE program, lead to the development of silicon-based neuromorphic card technologies, which allow a new type of computer inspired by the shape, the operation and the architecture of the brain to be built. The main advantages of these clockless systems are their energy efficiency and the fact that performance is proportional to the quantity of neurons and synapses used. A plurality of platforms were developed in this context, in particular:
IBM TrueNorth (Paul A. Merolla, et al.: “A Million Spiking-Neuron Integrated Circuit with a Scalable Communication Network and Interface”, Science, Vol. 345, No. 6197, pages 668-673, August 2014);
Neurogrid (Ben V. Benjamin, et al.: “Neurogrid: A Mixed-Analog-Digital Multichip System for Large-Scale Neural Simulations”, Proceedings of the IEEE, Vol. 102, No. 5, pages 699-716, May 2014);
SpiNNaker (Steve B. Furber, et al.: “The SpiNNaker Project”, Proceedings of the IEEE, Vol. 102, No. 5, pages 652-665, May 2014).

These machines substantially aim to simulate biology. Their main uses are in the field of learning, namely in order to execute deep learning architectures such as neural networks or deep belief networks. They are efficient in a plurality of fields like those of artificial vision, speech recognition, and language processing.

There are other options such as the NEF (“Neural Engineering Framework”) capable of simulating certain functionalities of the brain and in particular carrying out visual, cognitive and motor tasks (Chris Eliasmith, et al.: “A Large-Scale Model of the Functioning Brain”, Science, Vol. 338, No. 6111, pages 1202-1205, November 2012).

These various approaches do not propose a general methodology for executing calculations in a programmable machine.

### BRIEF SUMMARY

An object of the present disclosure is to propose a novel approach for the representation of the data and the execution of calculations. It is desirable for this approach to be suitable for an implementation having reduced energy consumption and massive parallelism.

A data processing device is proposed, comprising a set of processing nodes and connections between the nodes. Each connection has an emitter node and a receiver node out of the set of processing nodes and is configured to transmit, to the receiver node, events delivered by the emitter node. Each node is arranged to vary a respective potential value according to events that it receives and to deliver an event when the potential value reaches a predefined threshold. At least one input value of the data processing device is represented by a time interval between two events received by at least one node, and at least one output value of the data processing device is represented by a time interval between two events delivered by at least one node.

The processing nodes form neuron-type calculation units. However, it is not especially desired here to imitate the operation of the brain. The term “neuron” is used in the present disclosure for linguistic convenience but does not necessarily mean strong resemblance to the operating mode of the neurons of the cortex.

By using a specific temporal organisation of the events in the processing device, as well as various properties of the connections (synapses), an overall calculation framework, suitable for calculating the elementary mathematical functions, can be obtained. All the existing mathematical operators can then be implemented, whether linear or not, without necessarily having to use a Von Neumann architecture. From that point on, it is possible for the device to function like a conventional computer, but without requiring incessant back-and-forth trips to the memory and without being based on floating point precision. It is the temporal concurrence of synaptic events, or their temporal offsets, that form the basis for the representation of the data.

The proposed methodology is consistent with the neuromorphic architectures that do not make any distinction between memory and calculation. Each connection of each processing node stores information and simultaneously uses this information for the calculation. This is very different from the prevailing organisation in conventional computers that distinguishes between memory and processing and causes the Von Neumann bottleneck, in which the majority of the calculation time is dedicated to moving information between the memory and the central processing unit (John Backus: “Can Programming Be Liberated from the von Neumann Style?: A Functional Style and Its Algebra of Programs”, Communications of the ACM, Vol. 21, No. 8, pages 613-641, August 1978).

The operation is based on communication governed by events (“event-driven”) like in biological neurons, and thus allowing execution with massive parallelism.

In one embodiment of the device, each processing node is arranged to reset its potential value when it delivers an event. The reset can in particular be to a zero potential value.

Numerous embodiments of the device for processing data include, among the connections between the nodes, one or more potential variation connections, each having a respective weight. The receiver node of such a connection is arranged to respond to an event received on this connection by adding the weight of the connection to its potential value.

The potential variation connections can include excitation connections, which have a positive weight, and inhibiting connections, which have a negative weight.

In order to manipulate a value in the device, the set of processing nodes can comprise at least one first node forming the receiver node of a first potential variation connection having a first positive weight at least equal to the predefined threshold for the potential value, and at least one second node forming the receiver node of a second potential variation connection having a weight at least equal to half the predefined threshold for the potential value and less than the predefined threshold for the potential value. The aforementioned first node further forms the emitter node and the receiver node of a third potential variation connection having a weight equal to the opposite of the first weight, as well as the emitter node of a fourth connection, while the second node further forms the emitter node of a fifth connection. The first and second potential variation connections are thus configured to each receive two events separated by a first time interval representing an input value whereby the fourth and fifth connections transport respective events having between them a second time interval related to the first time interval.

Various operations can be carried out using a device according to the invention.

In particular, an example of a device for processing data comprises at least one minimum calculation circuit, which itself comprises:

first and second input nodes;

an output node;

first and second selection nodes;

first, second, third, fourth, fifth and sixth potential variation connections, each having a first positive weight at least equal to half the predefined threshold for the potential value and less than the predefined threshold for the potential value;

seventh and eighth potential variation connections each having a second weight opposite to the first weight; and

ninth and tenth potential variation connections each having a third weight double of the second weight.

In this minimum calculation circuit, the first input node forms the emitter node of the first and third connections and the receiver node of the tenth connections, the second input node forms the emitter node of the second and fourth connections and the receiver node of the ninth connection, the first selection node forms the emitter node of the fifth, seventh and ninth connections and the receiver node of the first and eighth connections, the second selection node forms the emitter node of the sixth, eighth and tenth connections and the receiver node of the second and seventh connections, and the output node forms the receiver node of the third, fourth, fifth and sixth connections.

Another example of a device for processing data comprises at least one maximum calculation circuit, which itself comprises:

first and second input nodes;

an output node;

first and second selection nodes;

first, second, third and fourth potential variation connections, each having a first positive weight at least equal to half the predefined threshold for the potential value and less than the predefined threshold for the potential value; and

fifth and sixth potential variation connections each having a second weight equal to double the opposite of the first weight.

In this maximum calculation circuit, the first input node forms the emitter node of the first and third connections, the second input node forms the emitter node of the second and fourth connections, the first selection node forms the emitter node of the fifth connection and the receiver node of the first and sixth connections, the second selection node forms the emitter node of the sixth connection and the receiver node of the second and fifth connections, and the output node forms the receiver node of the third and fourth connections.

Another example of a device for processing data comprises at least one subtractor circuit, which itself comprises:

first and second synchronisation nodes;

first and second inhibition nodes;

first and second output nodes;

first, second, third, fourth, fifth and sixth potential variation connections each having a first positive weight at least equal to the predefined threshold for the potential value;

seventh and eighth potential variation connections each having a second weight equal to half the first weight;

ninth and tenth potential variation connections each having a third weight opposite to the first weight; and

eleventh and twelfth potential variation connections each having a fourth weight double of the third weight.

In this subtractor circuit, the first synchronisation node forms the emitter node of the first, second, third and ninth connections, the second synchronisation node forms the emitter node of the fourth, fifth, sixth and tenth connections, the first inhibition node forms the emitter node of the eleventh connection and the receiver node of the third, eighth and tenth connections, the second inhibition node forms the emitter node of the twelfth connection and the receiver node of the sixth, seventh and ninth connections, the first output node forms the emitter node of the seventh connection and the receiver node of the first, fifth and eleventh connections, and the second output node forms the emitter node of the eighth connection and the receiver node of the second, fourth and twelfth connections. The first synchronisation node is configured to receive, on at least one potential variation connection having the second weight, a first pair of events having between them a first interval of time representing a first operand. The second synchronisation node is configured to receive, on at least one potential variation connection having the second weight, a second pair of events having between them a second interval of time representing a second operand, whereby a third pair of events having between them a third time interval is delivered by the first output node if the first time interval is longer than the second time interval and by the second output node if the first time interval is shorter than the second time interval, the third time interval representing the absolute value of the difference between the first and second operand.

The subtractor circuit can further comprise zero detection logic including at least one detection node associated with detection and inhibition connections with the first and second synchronisation nodes, one of the first and second inhibition nodes and one of the first and second output nodes. The detection and inhibition connections are faster than the first, second, third, fourth, fifth, sixth, seventh, eighth, ninth, tenth, eleventh and twelfth connections, in order to inhibit the production of events by one of the first and second output nodes when the first and second time intervals are substantially equal.

In various embodiments of the device, the set of processing nodes comprises at least one node arranged to vary a current value according to events received on at least one current adjustment connection, and to vary its potential value over time at a rate proportional to said current value. Such a processing node can in particular be arranged to reset its current value to zero when it delivers an event.

The current value in at least some of the nodes has a component that is constant between two events received on at least one constant current component adjustment connection having a respective weight. The receiver node of a constant current component adjustment connection is arranged to react to an event received on this connection by adding the weight of the connection to the constant component of its current value.

Another example of a device for processing data comprises at least one inverter memory circuit, which itself comprises:

an accumulator node;

first, second and third constant current component adjustment connections, the first and third connections having the same positive weight and the second connection having a weight opposite to the weight of the first and third connections; and

at least one fourth connection,

In this inverter memory circuit, the accumulator node forms the receiver node of the first, second and third connections and the emitter node of the fourth connection, and the first and second connections are configured to respectively address, to the accumulator node, first and second events having between them a first time interval related to a time interval representing a value to be memorised, whereby the accumulator node then responds to a third event received on the third connection by increasing its potential value until delivery of a fourth event on the fourth connection, the third and fourth events having between them a second time interval related to the first time interval.

Another example of a device for processing data comprises at least one memory circuit, which itself comprises:

first and second accumulator nodes;

first, second, third and fourth constant current component adjustment connections, the first, second and fourth connections each having a first positive weight and the third connection having a second weight opposite to the first weight; and

at least one fifth connection.

In this memory circuit, the first accumulator node forms the receiver node of the first connection and the emitter node of the third connection, the second accumulator node forms the receiver node of the second, third and fourth and fifth connections and the emitter node of the fifth connection, the first and second connection are configured to respectively address, to the first and second accumulator nodes, first and second events having between them a first time interval related to a time interval representing a value to be memorised, whereby the second accumulator node then responds to a third event received on the fourth connection by increasing its potential value until delivery of a fourth event on the fifth connection, the third and fourth events having between them a second time interval related to the first time interval.

The memory circuit can further comprise a sixth connection having the first accumulator node as an emitter node, the sixth connection delivering an event to signal the availability of the memory circuit for reading.

Another example of a device for processing data comprises at least one synchronisation circuit, which includes a number N>1 of memory circuits, of the type mentioned just above, and a synchronisation node. The synchronisation node is sensitive to each event delivered on the sixth connection of one of the N memory circuits via a respective potential variation connection having a weight equal to the first weight divided by N. The synchronisation node is arranged to trigger simultaneous reception of the third events via the respective fourth connections of the N memory circuits.

Another example of a device for processing data comprises at least one accumulation circuit, which itself comprises:

N inputs each having a respective weighting coefficient, N being an integer greater than 1;

an accumulator node;

a synchronisation node;

for each of the N inputs of the accumulation circuit:

a first constant current component adjustment connection having a first positive weight proportional to the respective weighting coefficient of said input; and

a second constant current component adjustment connection having a second weight opposite to the first weight;

a third constant current component adjustment connection having a third positive weight.

In this accumulation circuit, the accumulator node forms the receiver node of the first, second and third connections, the synchronisation node forms the emitter node of the third connection. For each of the Ninputs, the first and second connections are configured to address, to the accumulator node, respective first and second events having between them a first time interval representing a respective operand provided on said input. The synchronisation node is configured to deliver a third event once the first and second events have been addressed for each of the N inputs, whereby the accumulator node increases its potential value until delivery of a fourth event. The third and fourth events have between them a second time interval related to a time interval representing a weighted sum of the operands provided on the N inputs.

In an example of a device for processing data according to the invention, the accumulation circuit is part of a weighted addition circuit further comprising:

a second accumulator node;

a fourth constant current component adjustment connection having the third weight; and

a fifth and sixth connection.

In this weighted addition circuit, the synchronisation node of the accumulation circuit forms the emitter node of the fourth connection, the accumulator node of the accumulation circuit forms the emitter node of the fifth connection, and the second accumulator node forms the receiver node of the fourth connection and the emitter node of the sixth connection. In response to delivery of the third event by the synchronisation node, the accumulator node of the accumulation circuit increases its potential value until delivery of a fourth event on the fifth connection, and the second accumulator node increases its potential value until delivery of a fifth event on the sixth connection, the fourth and fifth events having between them a third time interval related to a time interval representing a weighted sum of the operands provided on the N inputs of the accumulation circuit.

Another example of a device for processing data comprises at least one linear combination circuit including two accumulation circuits, which share their synchronisation node, and a subtractor circuit configured to respond to the third event delivered by the shared synchronisation node and to the fourth events respectively delivered by the accumulator nodes of the two accumulation circuits by delivering a pair of events having between them a third time interval representing the difference between the weighted sum for one of the two accumulation circuits and the weighted sum for the other of the two accumulation circuits.

In some embodiments of the device, the set of processing nodes comprises at least one node, the current value of which has a component that decreases exponentially between two events received on at least one exponentially decreasing current component adjustment connection having a respective weight. The receiver node of an exponentially decreasing current component adjustment connection is arranged to react to an event received on this connection by adding the weight of the connection to the exponentially decreasing component of its current value.

Another example of a device for processing data comprises at least one logarithm calculation circuit, which itself comprises:

an accumulator node;

first and second constant current component adjustment connection, the first connection having a positive weight, and the second connection having a weight opposite to the weight of the first connection;

a third exponentially decreasing current component adjustment connection; and

at least one fourth connection.

In this logarithm calculation circuit, the accumulator node forms the receiver node of the first, second and third connections and the emitter node of the fourth connection. The first and second connections are configured to address, to the accumulator node, respective first and second events having between them a first time interval related to a time interval representing an input value of the logarithm calculation circuit. The third connection is configured to address, to the accumulator node, a third event simultaneous or posterior to the second event, whereby the accumulator node increases its potential value until delivery of a fourth event on the fourth connection, the third and fourth events having between them a second time interval related to a time interval representing a logarithm of the input value.

The processing device can further comprise at least one deactivation connection, the receiver node of which is a node capable of cancelling out its exponentially decreasing component of current in response to an event received on the deactivation connection.

Another example of a device for processing data comprises at least one exponentiation circuit, which itself comprises:

an accumulator node;

a first exponentially decreasing current component adjustment connection;

a second deactivation connection;

a third constant current component adjustment connection; and

at least one fourth connection.

In this exponentiation circuit, the accumulator node forms the receiver node of the first, second and third connections and the emitter node of the fourth connection. The first and second connection are configured to address, to the accumulator node, respective first and second events having between them a first time interval related to a time interval representing an input value of the exponentiation circuit. The third connection is configured to address, to the accumulator node, a third event simultaneous or posterior to the second event, whereby the accumulator node increases its potential value until delivery of a fourth event on the fourth connection, the third and fourth events having between them a second time interval related to a time interval representing an exponentiation of the input value.

Another example of a device for processing data comprises at least one multiplier circuit, which itself comprises:

first, second and third accumulator nodes;

a synchronisation node;

first, second, third, fourth and fifth constant current component adjustment connections, the first, third and fifth connections having a positive weight, and the second and fourth connections having a weight opposite to the weight of the first, second and fifth connections;

sixth, seventh and eighth exponentially decreasing current component adjustment connections;

a ninth deactivation connection; and

at least one tenth connection.

In this multiplier circuit, the first accumulator node forms the receiver node of the first, second and sixth connections and the emitter node of the seventh connection, the second accumulator node forms the receiver node of the third, fourth and seventh connections and the emitter node of the fifth and ninth connections, the third accumulator node forms the receiver node of the fifth, eighth and ninth connections and the emitter node of the tenth connection, and the synchronisation node forms the emitter node of the sixth and eighth connections. The first and second connection are configured to address, to the first accumulator node, respective first and second events having between them a first time interval related to a time interval representing a first operand of the multiplier circuit. The third and fourth connections are configured to address, to the second accumulator node, respective third and fourth events having between them a second time interval related to a time interval representing a second operand of the multiplier circuit. The synchronisation node is configured to deliver a fifth event on the sixth and eighth connections once the first, second, third and fourth events have been received. Thus, the first accumulator node increases its potential value until delivery of a sixth event on the seventh connection and then, in response to the sixth event, the second accumulator node increases its potential value until delivery of a seventh event on the fifth and ninth connections. In response to this seventh event, the third accumulator node increases its potential value until delivery of an eighth event on the tenth connection, the seventh and eighth events having between them a third time interval related to a time interval representing the product of the first and second operands.

Sign detection logic can be associated with the multiplier circuit in order to detect the respective signs of the first and second operands and cause two events having between them a time interval representing the product of the first and second operands to be delivered on one or the other of two outputs of the multiplier circuit according to the signs detected.

In a typical embodiment of the processing device, each connection is associated with a delay parameter, in order to signal the receiver node of this connection to carry out a change of state with a delay, with respect to the reception of an event on the connection, indicated by said parameter.

The time interval Δt between two events representing a value having an absolute value x can have, in particular, the form Δt=Tₘᵢₙ+x·T_{cod}, where Tₘᵢₙ and T_{cod} are predefined time parameters. The values represented by time intervals have, for example, absolute values x between 0 and 1.

A logarithmic scale rather than a linear one for Δt as a function of x can also be suitable for certain uses. Other scales can also be used.

The processing device can have special arrangements in order to handle signed values. It can thus comprise, for an input value:

a first input comprising one node or two nodes out of the set of processing nodes, the first input being arranged to receive two events having between them a time interval representing a positive value of the input value; and

a second input comprising one node or two nodes out of the set of processing nodes, the second input being arranged to receive two events having between them a time interval representing a negative value of the input value.

For an output value, the processing device can comprise:

a first output comprising one node or two nodes out of the set of processing nodes, the first output being arranged to deliver two events having between them a time interval representing a positive value of said output value; and

a second output comprising one node or two nodes out of the set of processing nodes, the second output being arranged to deliver two events having between them a time interval representing a negative value of said output value.

In an embodiment of the processing device, the set of processing nodes is in the form of at least one programmable array, the nodes of the array having a shared behaviour model according to the events received. This device further comprises a programming logic in order to adjust weights and delay parameters of the connections between the nodes of the array according to a calculation program, and a control unit in order to provide input values to the array and recover output values calculated according to the program.

### BRIEF DESCRIPTION OF THE SEVERAL VIEWS OF THE DRAWINGS

Other features and advantages of the present invention will appear in the following description, in reference to the appended drawings, in which:

FIG. 1 is a diagram of a processing circuit producing the representation of a constant value on demand, according to an embodiment of the invention;

FIG. 2 is a diagram of an inverter memory device according to an embodiment of the invention;

FIG. 3 is a diagram showing the change in potential values over time and the production of events in an inverter memory device according to FIG. 2;

FIG. 4 is a diagram of a memory device according to an embodiment of the invention;

FIG. 5 is a diagram showing the change in potential values over time and the production of events in a memory device according to FIG. 4;

FIG. 6 is a diagram of a signed memory device according to an embodiment of the invention;

FIGS. 7(a) and 7(b) are diagrams showing the change in potential values over time and the production of events in a signed memory device according to FIG. 6 when it is presented with various input values;

FIG. 8 is a diagram of a synchronisation device according to an embodiment of the invention;

FIG. 9 is a diagram showing the change in potential values over time and the production of events in a synchronisation device according to FIG. 8;

FIG. 10 is a diagram of a synchronisation device according to another embodiment of the invention;

FIG. 11 is a diagram of a device for calculating a minimum according to an embodiment of the invention;

FIG. 12 is a diagram showing the change in potential values over time and the production of events in a device for calculating a minimum according to FIG. 11;

FIG. 13 is a diagram of a device for calculating a maximum according to an embodiment of the invention;

FIG. 14 is a diagram showing the change in potential values over time and the production of events in a device for calculating a maximum according to FIG. 13;

FIG. 15 is a diagram of a subtractor device according to an embodiment of the invention;

FIG. 16 is a diagram showing the change in potential values over time and the production of events in a subtractor device according to FIG. 15;

FIG. 17 is a diagram of an alternative of the subtractor device in which a difference equal to zero is taken into account;

FIG. 18 is a diagram of an accumulation circuit according to an embodiment of the invention;

FIG. 19 is a diagram of a weighted addition device according to an embodiment of the invention;

FIG. 20 is a diagram of a linear combination calculation device according to an embodiment of the invention;

FIG. 21 is a diagram of a logarithm calculation device according to an embodiment of the invention;

FIG. 22 is a diagram showing the change in potential values over time and the production of events in a logarithm calculation device according to FIG. 21;

FIG. 23 is a diagram of an exponentiation device according to an embodiment of the invention;

FIG. 24 is a diagram showing the change in potential values over time and the production of events in an exponentiation device according to FIG. 23;

FIG. 25 is a diagram of a multiplier device according to an embodiment of the invention;

FIG. 26 is a diagram showing the change in potential values over time and the production of events in a multiplier device according to FIG. 25;

FIG. 27 is a diagram of a signed multiplier device according to an embodiment of the invention;

FIG. 28 is a diagram of an integrator device according to an embodiment of the invention;

FIG. 29 is a diagram of a device suitable for solving a first-order differential equation in an example of an embodiment of the invention;

FIGS. 30A and 30B are graphs showing results of simulation of the device of FIG. 29;

FIG. 31 is a diagram of a device suitable for solving a second-order differential equation in an example of an embodiment of the invention;

FIGS. 32A and 32B are graphs showing results of simulation of the device of FIG. 31;

FIG. 33 is a diagram of a device suitable for solving a system of three-variable nonlinear differential equations in an example of an embodiment of the invention;

FIG. 34 is a graph showing results of simulation of the device of FIG. 33;

FIG. 35 is a diagram of a programmable processing device according to an embodiment of the invention.

### DETAILED DESCRIPTION

A data processing device as proposed here works by representing the processed values not as amplitudes of electric signals or as binary-encoded numbers processed by logic circuits, but as time intervals between events occurring within a set of processing nodes having connections between them.

In the context of the present disclosure, an embodiment of the data processing device according to an architecture similar to those of artificial neural networks is presented. Although the data processing device does not necessarily have an architecture strictly corresponding to that which people agree to call “neural networks”, the following description uses the terms “node” and “neuron” interchangeably, just like it uses the term “synapse” to designate the connections between two nodes or neurons in the device.

The synapses are oriented, i.e. each connection has an emitter node and a receiver node and transmits, to the receiver node, events generated by the emitter node. An event typically manifests itself as a spike in a voltage signal or current signal delivered by the emitter node and influencing the receiver node.

As is usual in the context of artificial neural networks, each connection or synapse has a weight parameter w that measures the influence that the emitter node exerts on the receiver node during an event.

A description of the behaviour of each node can be given by referring to a potential value V corresponding to the membrane potential V in the paradigm of artificial neural networks. The potential value V of a node varies over time according to the events that the node receives on its incoming connections. When this potential value V reaches or exceeds a threshold Vₜ, the node emits an event (“spike”) that is transmitted to the node(s) located downstream.

In order to describe the behaviour of a node, or neuron, in an exemplary embodiment of the invention, reference can further be made to a current value g having a component gₑ and optionally a component g_{ƒ}.

The component gₑ is a component that remains constant, or substantially constant, between two events that the node receives on a particular synapse that is called here constant current component adjustment connection.

The component g_{ƒ} is an exponentially changing component, i.e. it varies exponentially between two events that the node receives on a particular synapse that is called here exponentially decreasing current component adjustment connection.

A node that takes into account an exponentially decreasing current component g_{ƒ} can further receive events for activation and deactivation of the component g_{ƒ} on a particular synapse that is called here activation connection.

In the example in question, the behaviour of a processing node can therefore be expressed in a generic manner by a set of differential equations:

$$\{ \begin{matrix}{τ}_{m} \cdot \frac{dV}{dt} = {g}_{e} + gate . {g}_{f} \\ \frac{d {g}_{e}}{dt} = 0 \\ {τ}_{f} \cdot \frac{d {g}_{f}}{dt} = - {g}_{f}\end{matrix} \qquad ( 1 )$$

where:
t designates time;
the component gₑ represents a constant input current that can only be changed by synaptic events;
the component g_{ƒ} represents an exponentially changing input current;
gate is a binary activation (gate=1) or deactivation (gate=0) signal of the exponentially decreasing current component g_{\dot{ƒ}},
τₘ, is a time constant regulating the linear variation in the potential value V as a function of the current value g=gₑ+gate·g_{\dot{ƒ}},
   and τⱼ is a time constant regulating the exponential change in the decrease in the component g_{ƒ}.

In the system (1), it is considered that there is no leak of the membrane potential V, or that the dynamics of this leak are on a much larger time scale than all the other dynamics operating in the device.

In this model, four types of synapses that influence the behaviour of a neuron can be distinguished, each synapse being associated with a weight parameter indicating a synaptic weight w, positive or negative:
potential variation connections, or V-synapses, which directly modify the value of the membrane potential of the neuron: V←V+w. In other words, the receiver node responds to an event received on a V-synapse by adding, to its potential value V, the weight w indicated by the weight parameter;
constant current component adjustment connections, or gₑ-synapses, which directly modify the constant input current of the neuron: gₑ←gₑ+w. In other words, the receiver node responds to an event received on a gₑ-synapse by adding, to the constant component of its current value, the weight w indicated by the weight parameter;
exponentially decreasing current component adjustment connections, or g_{\dot{ƒ}}-synapses, which directly modify the exponentially changing input current of the neuron: g_{ƒ} ←g_{ƒ}+w. In other words, the receiver node reacts to an event received on a g_{ƒ}-synapse by adding, to the exponentially decreasing component of its current value, the weight w indicated by the weight parameter;
and activation connections, or gate-synapses, which activate the neuron by setting gate←1 when they indicate a positive weight w=1 and deactivate the neuron by setting gate←0 when they indicate a negative weight w=−1.

Each synaptic connection is further associated with a delay parameter that gives the delay in propagation between the emitter neuron and the receiver neuron.

A neuron triggers an event, when its potential value V reaches a threshold Vₜ, i.e.:

V≥Vₜ (2)

The triggering of the event gives rise to a spike delivered on each synapse of which the neuron forms the emitter node and to resetting its state variables to:

V←Vᵣₑₛₑₜ (3)

gₑ←0 (4)

g_{ƒ}←0 (5)

gate←0 (6)

Without losing any generality, the case where Vᵣₑₛₑₜ=0 can be considered.

Hereinafter, the notation T_{syn} designates the delay in propagation along a standard synapse, and the notation Tₙₑᵤ designates the time that a neuron takes to transmit the event when producing its spike after having been triggered by an input synaptic event. Tₙₑᵤ can for example represent the time step of a neural simulator.

A standard weight wₑ is defined as the minimum excitation weight that must be applied to a V-synapse in order to trigger a neuron from the reset state, and another standard weight W is defined as the inhibition weight having a contrary effect:

wₑ=Vₜ (7)

wᵢ=wₑ (8)

The values processed by the device are represented by time intervals between events. Two events of a pair of events are separated by a time interval Δt that is a function of the value x encoded by this pair:

Δt=ƒ(x) (9)

where ƒ is an encoding function chosen for the representation of the data in the device.

The two events of the pair encoding this value x can be delivered by the same neuron n or by two distinct neurons.

In the case of the same neuron n, delivering events at successive times eₙ(i), i=0, 1, 2, etc., it can be considered that this neuron n encodes a time-varying signal u(t), the discrete values of which are given by:

u(eₙ(i))=ƒ⁻¹(eₙ(i+1)−eₙ(i)),∀i==2·p,p∈ [symbol] , (10)

where ƒ⁻¹ is the encoding function inverse chosen and i is an even number.

The encoding function ƒ:= [symbol] → [symbol] can be chosen while taking into account the signals processed in a particular system, and adapted to the required precision. The function ƒ calculates the interval between spikes associated with a particular value. In the rest of the present description, embodiments of the processing device using a linear encoding function are illustrated:

Δt=ƒ(x)=Tₘᵢₙ+x·T_{cod} (11)

with x∈[0, 1].

This representation of the function ƒ[0, 1]→[Tₘᵢₙ, Tₘₐₓ] allows any value x between 0 and 1 to be encoded linearly by a time interval between Tₘᵢₙ and Tₘₐₓ=Tₘᵢₙ+T_{cod}. The value of Tₘᵢₙ can be zero. However, it is advantageous for it to be non-zero. Indeed, if two events representing a value come from the same neuron or are received by the same neuron, the minimum interval Tₘᵢₙ>0 gives this neuron time to reset. Moreover, a choice of Tₘᵢₙ>0 allows certain arrangements of neurons to respond to the first input event and propagate a change of state before receiving a second event.

The form (11) for the encoding function ƒ is not the only one possible. Another suitable choice is to take a logarithmic function, which allows a wide range of values to be encoded with dynamics that are suitable for certain uses, in this case with less precision for large values.

To represent signed values, two different paths, one for each sign, can be used. Positive values are thus encoded using a particular neuron, and negative values using another neuron. Arbitrarily, zero can be represented as a positive value or a negative value. Hereinafter, it is represented as a positive value.

Thus, to continue the example of form (11), if a value x has a value in the range [−1, +1], it is represented by a time interval Δt=Tₘᵢₙ+|x|·T_{cod} between two events propagated on the path associated with the positive values if x≥0 and on the path associated with the negative values if x<0.

The choice of (9) or (11) for the encoding function leads to the definition of two standard weights for the gₑ-synapses. The weight w_{acc} is defined as being the value of gₑ necessary to trigger a neuron, from its reset state, after the time Tₘₐₓ=Tₘᵢₙ+T_{cod}, i.e., considering (1):

$${w}_{acc} = {V}_{t} \cdot \frac{{τ}_{m}}{{T}_{max}} \qquad ( 12 )$$

Moreover, the weight w̅_{acc} is defined as being the value of gₑ necessary to trigger a neuron, from its reset state, after the time T_{cod}, or:

$${\overline{w}}_{acc} = {V}_{t} \cdot \frac{{τ}_{m}}{{T}_{cod}} \qquad ( 13 )$$

For the gₑ-synapses, another standard weight gₘᵤₗₜ can be given as:

$${g}_{mult} = {V}_{t} \cdot \frac{{τ}_{m}}{{τ}_{f}} \qquad ( 14 )$$

The connections between nodes of the device can further be each associated with a respective delay parameter. This parameter indicates a delay with which the receiver node of the connection carries out a change of state, with respect to the emission of an event on the connection. The indication of delay values by these delay parameters associated with the synapses allows suitable sequencing of the operations in the processing device to be ensured.

Various technologies can be used to implement the processing nodes and their interconnections in order for them to behave in the way described by the equations (1)-(6), namely the technologies routinely used in the well-known field of artificial neural networks. Each node can, for example, be created using analogue technology, with resistive and capacitive elements in order to preserve and vary a voltage level and transistor elements in order to deliver events when the voltage level exceeds the threshold Vₜ.

Another possibility is to use digital technologies, for example based on field-programmable gate arrays (FPGAs), which provide a convenient means for implementing artificial neurons.

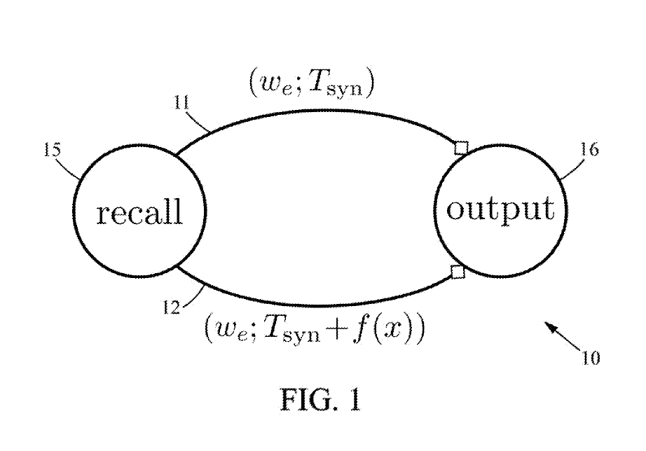

Below, a certain number of devices or circuits for processing data that are made using interconnected processing nodes are presented. In FIGS. 1, 2, 4, 6, 8, 10, 11, 13, 15, 17, 18, 19, 20, 21, 23, 25, 27, 28, 29, 31 and 33:
the connections between nodes shown as solid lines are V-synapses;
the connections shown as dashed lines are gₑ-synapses;
the connections shown as chain dotted lines are g_{ƒ}-synapses;
the connections shown as dotted lines are gate-synapses;
the connections are oriented with a symbol on the side of their receiver nodes. This symbol is an open square for an excitation connection, i.e. a connection having a positive weight, and a closed square for an inhibiting connection, i.e. a connection having a negative weight;
the pair of parameters (w; T) next to a connection indicates the weight w and the delay T associated with the connection. Sometimes, only the weight w is indicated.

Some of the nodes or neurons shown in these drawings are named in such a way as to evoke the functions resulting from their arrangement in the circuit: ‘input’ for an input neuron, ‘input+’ for the input of a positive value, ‘input’ for the input of a negative value, “output” for an output neuron, ‘output+’ for the output of a positive value, ‘output−’ for the output of a negative value, ‘recall’ for a neuron used to recover a value, ‘acc’ for an accumulator neuron, ‘ready’ for a neuron indicating the availability of a result or of a value, etc.

FIG. 1 shows a very simple circuit 10 that can be used to produce the representation of a constant value x on demand. The two V-synapses 11, 12 having weights greater than or equal to wₑ (in the example shown, the weights are taken equal to wₑ) each have a recall neuron 15 as an emitter node and a output neuron 16 as a receiver node. The synapse 11 is configured with a delay parameter T_{syn}, while the synapse 12 is configured with a delay parameter T_{syn}+ƒ(x).

The activation of the recall neuron 15 triggers the output neuron 16 at times T_{syn} and T_{syn}+ƒ(x), and thus the circuit 10 delivers two events separated in time by the value ƒ(x) representing the constant x.

### A. Memories

A.1. Inverting Memory

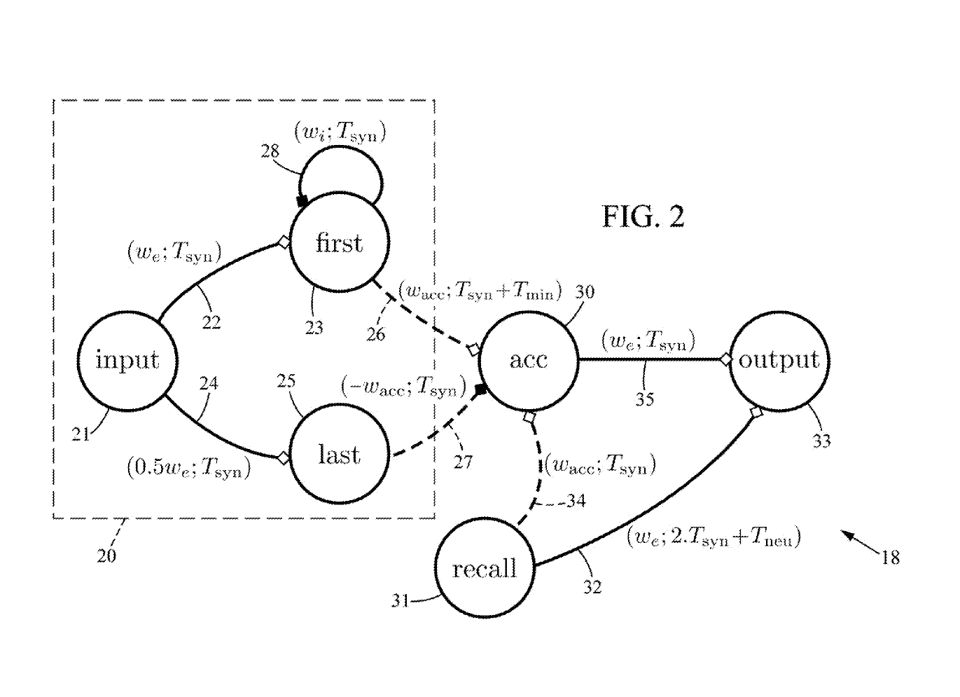

FIG. 2 shows a processing circuit 18 forming an inverting memory.

This device 18 stores an analogue value x encoded by a pair of input spikes provided at an input neuron 21 with an interval Δtᵢₙ=ƒ(x), using an integration of current over the dynamic range gₑ in an acc neuron 30. The value x is stored in the membrane potential of the acc neuron 30 and read during the activation of a recall neuron 31, which leads to delivering a pair of events separated by a time interval Δtₜ corresponding to the value 1−x at the output neuron 33, i.e. Δtₒᵤₜ=ƒ(1−x).

The input neuron 21 belongs to a group of nodes 20 used to produce two events separated by ƒ(x) Tₘᵢₙ=x·T_{cod} on gₑ-synapses 26, 27 directed towards the acc neuron 30. This group comprises a ‘first’ neuron 23 and a ‘last’ neuron 25. Two excitation V-synapses 22, 24 having a delay T_{syn} go from the input neuron 21 to the first neuron 23 and to the last neuron 25, respectively. The V-synapse 22 has a weight wₑ, while the V-synapse 24 has a weight equal to wₑ/2. The first neuron 23 inhibits itself via a V-synapse 28 having a weight wᵢ and a delay T_{syn}.

The excitation gₑ-synapse 26 goes from the first neuron 23 to the acc neuron 30, and has the weight w_{acc} and a delay of T_{syn}+Tₘᵢₙ. The inhibiting gₑ-synapse 27 goes from the last neuron 25 to the acc neuron 30, and has the weight −w_{acc} and a delay T_{syn}. An excitation V-synapse 32 goes from the recall neuron 31 to the output neuron 33, and has the weight wₑ and a delay of 2T_{syn}+Tₙₑᵤ. An excitation V-synapse 34 goes from the recall neuron 31 to the acc neuron 30, and has the weight w_{acc} and a delay T_{syn}. Finally, an excitation V-synapse 35 goes from the acc neuron 30 to the output neuron 33, and has the weight wₑ and a delay T_{syn}.

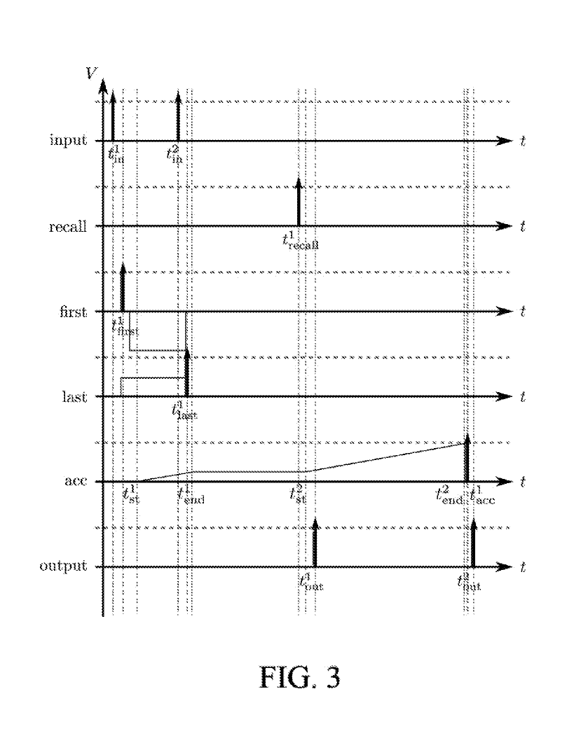

The operation of the inverting-memory device 18 is illustrated by FIG. 3.

Emission of a first event (spike) at time tᵢₙ¹ at the input neuron 21 triggers an event at the output of the first neuron 23 after the time T_{syn}+Tₙₑᵤ, i.e. at time t_{first}¹ in FIG. 3, and raises the potential value of the last neuron 25 to Vₜ/2. The first neuron 23 then inhibits itself via the synapse 28 by giving the value −Vₜ to its membrane potential, and it starts the accumulation by the acc neuron 30 after T_{syn}+Tₘᵢₙ, i.e. at time tₛₜ¹, via the gₑ-synapse 26.

The emission of the second spike at time tᵢₙ²=tᵢₙ¹+Tₘᵢₙ+x·T_{cod} at the input neuron 21 brings the last neuron 25 to the threshold potential Vₜ. An event is then produced at time tₗₐₛₜ¹=tᵢₙ²+T_{syn}+Tₙₑᵤ on the inhibiting gₑ-synapse 27. The second spike also triggers the resetting of the potential of the first neuron 23 to zero via the synapse 22. The event transported by the gₑ-synapse 27 in response to the second spike stops the accumulation carried out by the acc neuron 30 at time t_{end}¹=tₛₜ¹+x·T_{cod}.

At this stage, the potential value

$${V}_{t} \cdot x \cdot \frac{{T}_{cod}}{{T}_{max}}$$

is stored in the acc neuron 30 in order to memorise the value x. Its complement 1−x can then be read by activating the recall neuron 31, which takes place at time t_{recall}¹ in FIG. 3. This activation restarts the process of accumulation in the acc neuron 30 at time tₛₜ²=t_{recall}¹+T_{syn} and triggers an event at time tₒᵤₜ¹=t_{recall}¹+2T_{syn}+2Tₙₑᵤ on the output neuron 33. The accumulation continues in the acc neuron 30 until the time t_{end}² at which its potential value reaches the threshold Vₜ, i.e. t_{end}²=tₛₜ²+Tₘₐₓ−x·T_{cod}. An event is emitted on the V-synapse 35 at time t_{end}²+Tₙₑᵤ and triggers another event on the output neuron 33 at time tₒᵤₜ²=t_{end}²+T_{syn}+2Tₙₑᵤ=t_{recall}¹+2T_{syn}+2Tₙₑᵤ+Tₘᵢₙ+(1−x)·T_{cod}.

Finally, the two events delivered by the output neuron 33 are separated by a time interval ΔTₒᵤₜ=tₒᵤₜ²−tₒᵤₜ¹=Tₘᵢₙ+(1−x)·T_{cod}=ƒ (1−x).

It is noted that the value x is stored in the acc neuron 30 upon reception of the two input spikes and immediately available to be read by activating the recall neuron 31.

Since the standard weight wₑ was defined as the minimum excitation weight that must be applied to a V-synapse in order to trigger a neuron from the reset state, it is noted that the processing circuit 18 of FIG. 2 functions similarly if certain weights are chosen in the following manner: the V-synapse 22 has a weight w greater than or equal to wₑ, the V-synapse 24 has a weight at least equal to wₑ/2 and less than Vₜ, the first neuron 23 inhibits itself via a recall V-synapse 28 having a weight −w, the excitation V-synapse 32 has a weight greater than or equal to wₑ and the excitation V-synapse 35 has a weight greater than or equal to wₑ. This observation extends to the following processing circuits.

A.2. Memory

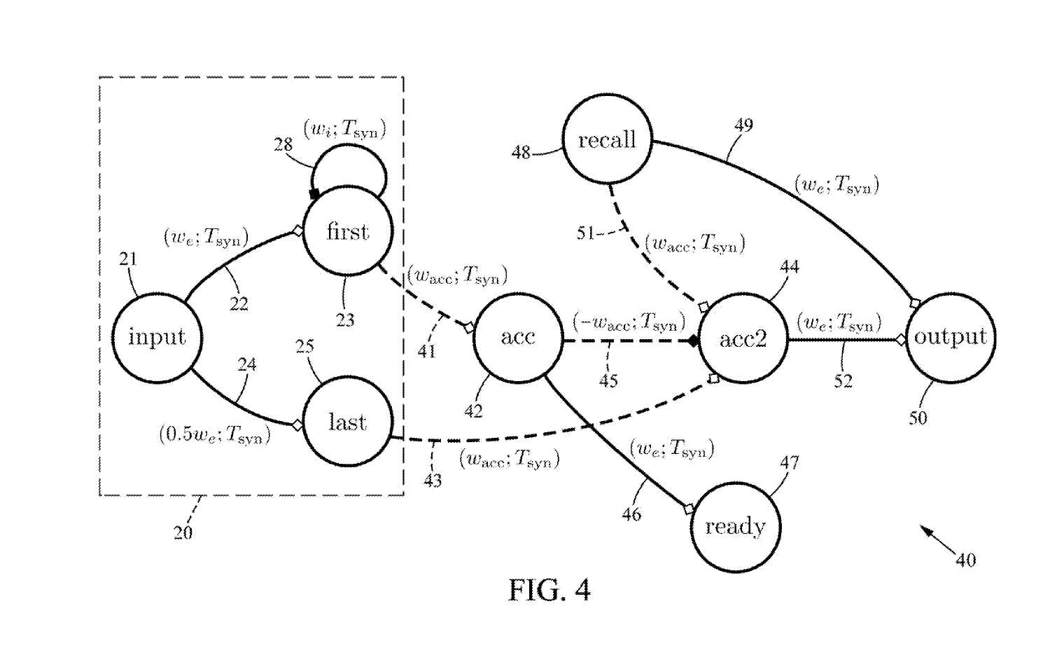

FIG. 4 shows a processing circuit 40 forming a memory.

This device 40 memorizes an analogue value x encoded by a pair of input spikes provided at a input neuron 21 with an interval Δtᵢₙ=ƒ(x), using an integration of current on the dynamic range gₑ in two cascaded acc neurons 42, 44 in order to form a non-inverting output with a pair of events separated by a time interval Δtₜ=ƒ(x).

The memory circuit 40 has an input neuron 21 in order to receive the value to be stored, a read-command input formed by a recall neuron 48, a ready neuron 47 indicating the time from which a reading command can be presented to the recall neuron 48, and an output neuron 50 in order to return the stored value. All the synapses of this memory circuit have the delay T_{syn}.

The input neuron 21 belongs to a group of nodes 20 similar to that described in reference to FIG. 2, with a first neuron 23 and a last neuron 25 in order to separate the two events produced with an interval of ƒ(x)=tₘᵢₙ+x·T_{cod} by the input neuron 21.

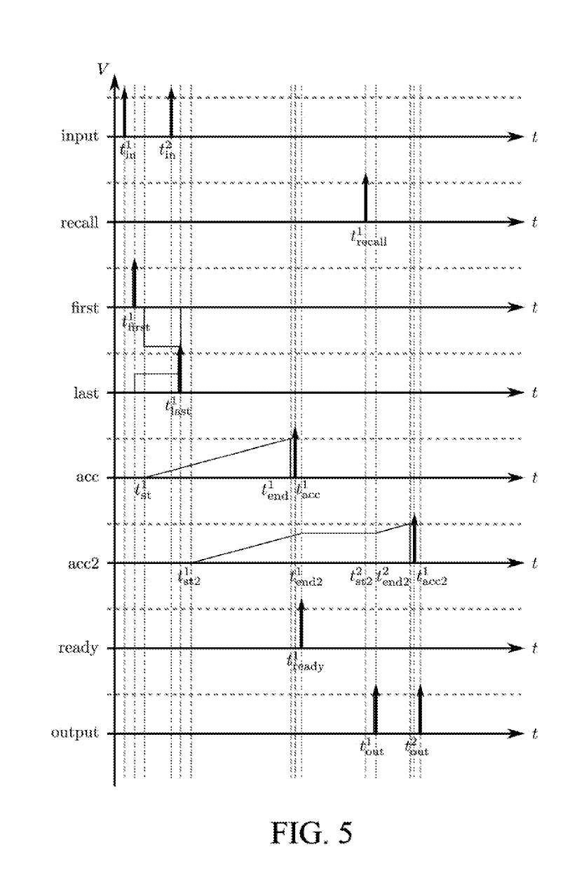

A gₑ-synapse 41 goes from the first neuron 23 to the first acc neuron 42, and has the weight w_{acc} The acc neuron 42 thus starts accumulation at time tₛₜ¹−tᵢₙ¹+2·T_{syn}+Tₙₑᵤ (FIG. 5). A gₑ-synapse 43 goes from the last neuron 25 to the second acc neuron 44, and has the weight w_{acc}. The acc neuron 44 thus starts accumulation at time tₛₜ₁¹=tᵢₙ²+2·T_{syn}+Tₙₑᵤ. At the output of the acc neuron 42, another gₑ-synapse 45 having the weight w_{acc} goes to the acc neuron 44, and a V-synapse 46 having the weight wₑ goes to the ready neuron 47.

The accumulation in the acc neuron 42 continues until the time t_{end}¹=tₛₜ¹+Tₘₐₓ at which the potential of the acc neuron 42 reaches the threshold Vₜ, which triggers the emission of a spike at time t_{acc}¹=t_{end}¹ Tₙₑᵤ on the gₑ-synapse 45 (FIG. 5). This spike stops the accumulation in the acc neuron 44 at time t_{end}¹=t_{acc}¹=T_{syn}=tᵢₙ¹+3·T_{syn}+2·Tₙₑᵤ+Tₘₐₓ. The triggering of the acc neuron 42 also triggers an event on the ready neuron 47 at time t_{ready}¹=t_{acc}¹+T_{syn}+Tₙₑᵤ.

At this stage, the potential value stored in the acc neuron 44 is

$$\frac{{V}_{t}}{{T}_{max}} \cdot ( {t}_{end 2}^{1} - {t}_{st 2}^{1} ) = {V}_{t} \cdot ( 1 - \frac{f ( x ) - {T}_{syn} - {T}_{neu}}{{T}_{max}} ) ,$$

which allows the value x to be memorized. The reading can then take place by activating the recall neuron 48, which takes place at time t_{recall}¹ in FIG. 5.

The activation of the recall neuron 48 triggers an event at time tₒᵤₜ¹=t_{recall}¹+T_{syn}+Tₙₑᵤ on the output neuron 50 via the V-synapse 49, and restarts the process of accumulation in the acc neuron 44 via the gₑ-synapse 51 at time tₛₜ₂²=t_{recall}¹ T_{syn}. The accumulation continues in the acc neuron 44 until the time t_{end2}² at which its potential value reaches the threshold Vₜ, i.e. t_{end2}²=tₛₜ₂²+ƒ (x)−T_{syn}−Tₙₑᵤ. An event is emitted on the V-synapse 52 at time t_{acc}¹=t_{end2}²=Tₙₑᵤ and triggers another event on the output neuron 50 at time tₒᵤₜ²=t_{acc2}¹+T_{syn}+Tₙₑᵤ=t_{recall}¹+T_{syn}+Tₙₑᵤ+ƒ(x).

Finally, the two events delivered by the output neuron 50 are separated by a time interval ΔTₒᵤₜ=tₒᵤₜ²−tₒᵤₜ¹=ƒ(x).

It is noted that the acc neuron 42 in FIG. 4 could be eliminated by configuring delays of T_{syn}+Tₘₐₓ on certain synapses. This could be of interest for reducing the number of neurons, but can pose a problem in an installation using specific integrated circuits (ASIC) because of the extension of the delays between neighbouring neurons.

It is also noted that the memory circuit 40 functions for any encoding of the value x by a time interval between Tₘᵢₙ and Tₘₐₓ, without being limited to the form (11) above.

A.3. Signed Memory

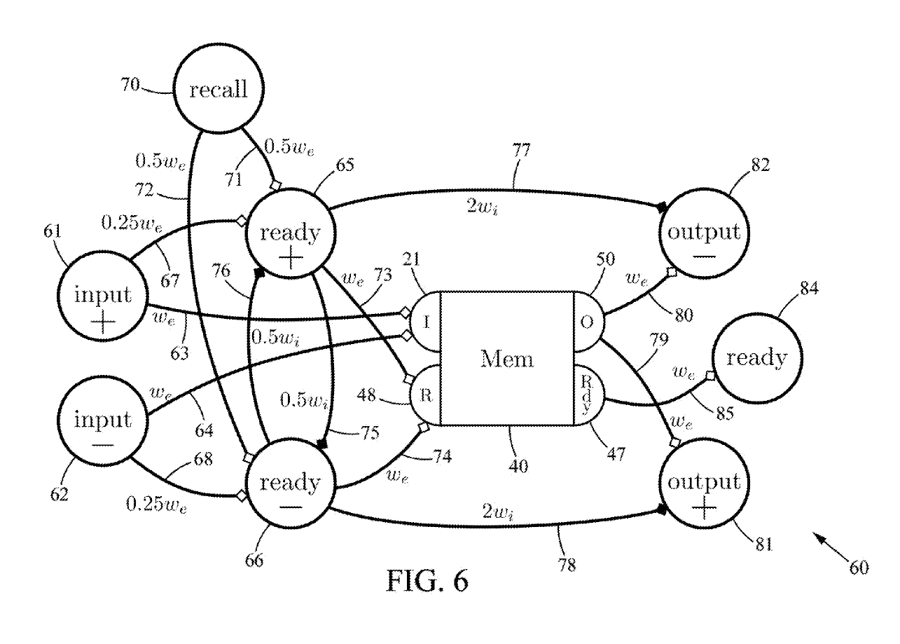

FIG. 6 shows a processing circuit 60 forming a memory for a signed value, between −1 and +1. Its absolute value is encoded by an interval Δtᵢₙ=ƒ(|x|) between two events that, if x≥0, are provided by the input+ neuron 61 and then returned by the output+ neuron 81 and, if x<0, are provided by the input− neuron 62 and then returned by the output− neuron 82. All the synapses of this memory circuit have the delay T_{syn}.

The signed-memory circuit 60 is based on a memory circuit 40 of the type shown in FIGS. 4A-B. The input+ and input− neurons 61, 62 are connected, respectively, to the input neuron 21 of the circuit 40 by excitation V-synapses 63, 64 having the weight wₑ. Thus, the one out of the neurons 61, 62 that receives the two spikes representing |x| activates the input neuron 21 of the circuit 40 twice, such that the time interval ƒ(|x|) is returned on the output neuron 50 of the circuit 40.

Moreover, the neurons 61, 62 are connected, respectively, to ready+ and ready− neurons 65, 66 by excitation V-synapses 67, 68 having a weight of wₑ/4. The signed memory circuit has a recall neuron 70 connected to the ready+ and ready− neurons 65, 66 by respective excitation V-synapses 71, 72 having the weight wₑ/2. Each of the ready+ and ready− neurons 65, 66 is connected to the recall neuron 48 of the circuit 40 by respective excitation V-synapses 73, 74 having the weight wₑ. An inhibiting V-synapse 75 having a weight of wᵢ/2 goes from the ready+ neuron 65 to the ready− neuron 66, and reciprocally, an inhibiting V-synapse 76 having a weight of wᵢ/2 goes from the ready neuron 66 to the ready+ neuron 65. The ready+ neuron 65 is connected to the output− neuron 82 of the signed memory circuit by an inhibiting V-synapse 77 having a weight of 2wᵢ. The ready− neuron 66 is connected to the output+ neuron 81 of the signed memory circuit by an inhibiting V-synapse 78 having a weight of 2wᵢ.

The output neuron 50 of the circuit 40 is connected to the output+ and output− neurons 81, 82 by respective excitation V-synapses 79, 80 having the weight wₑ.

The output of the signed memory circuit 60 comprises a ready neuron 84 that is the receiver node of an excitation V-synapse 85 having the weight wₑ coming from the ready neuron 47 of the memory circuit 40.

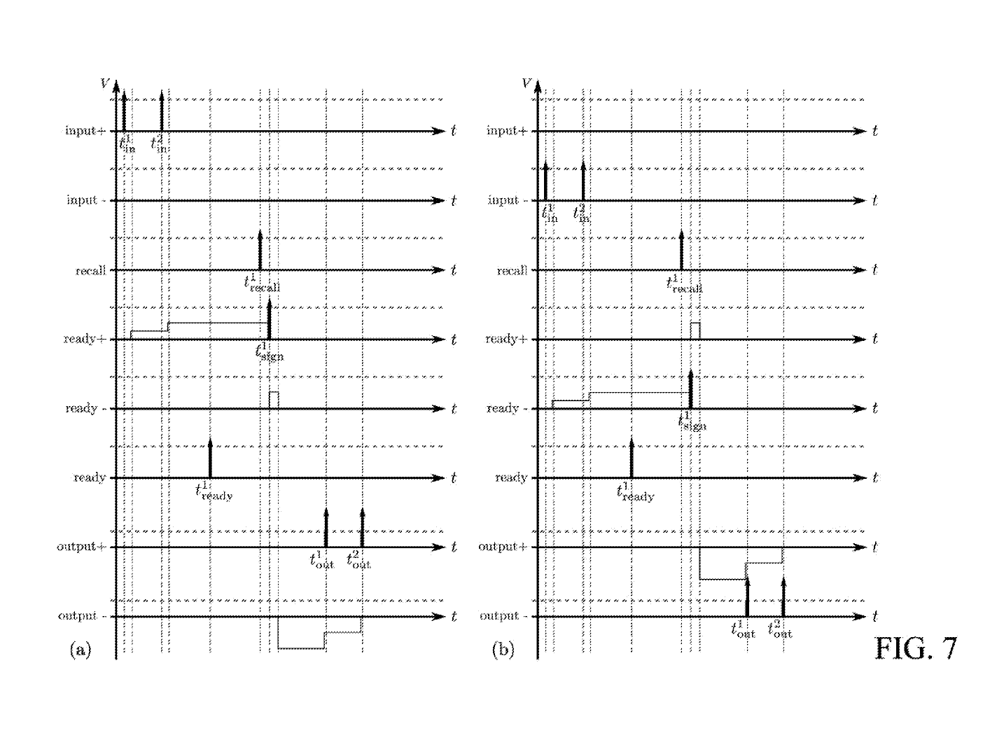

FIG. 7 shows the behaviour of the neurons of the signed-memory circuit 60 (a) in the case of a positive input and (b) in the case of a negative input. The appearance of the two events at times tᵢₙ¹ and tᵢₙ²=tᵢₙ¹+ƒ (x) on one of the neurons 61, 62 raises the potential of the ready+ or ready− neuron 65, 66 to the value Vₜ/2 in two steps. In parallel, the acc neuron 44 of the memory circuit 40 is charged to the value

$${V}_{t} \cdot ( 1 - \frac{f ( \vert x \vert ) - {T}_{syn} - {T}_{neu}}{{T}_{max}} )$$

and its ready neuron 47 produces an event at time t_{ready}¹, as described above.

Once the ready neuron 47 has produced its event, the ready neuron 70 can be activated in order to read the signed piece of data, which takes place at time t_{recall}¹ in FIG. 7.

Activation of the recall neuron 70 triggers the ready+ or ready− neuron 65, 66 via the V-synapse 70 or 71, and this triggering resets the other ready− or ready+ neuron 65, 66 to zero via the V-synapse 75 or 76. The event delivered by the ready+ or ready− neuron 65, 66 inhibits the output− or output+ neuron 82, 81 via the V-synapse 77 or 78 by bringing its potential to − 2Vₜ.

The event delivered by the ready+ or ready− neuron 65, 66 at time t_{sign}¹ is provided via the V-synapse 73 or 74. This triggers the emission of a pair of spikes separated by a time interval equal to ƒ(|x|) by the output neuron 50 of the circuit 40. This pair of spikes communicated to the output+ and output− neurons 81, 82 via the V-synapses 79, 80 twice triggers, at times tₒᵤₜ¹ and tₒᵤₜ²=tₒᵤₜ¹+ƒ(|x|), the one of the output+ and output− neurons 81, 82 that corresponds to the sign of the input piece of data x, and resets the potential value of the other neuron 81, 82 to zero.

It is noted that the signed-memory circuit 60 shown in FIG. 6 is not optimised in terms of number of neurons, because the following is possible:
eliminating the input neuron 21 of the memory circuit 40, by sending the V-synapses 63 and 64 directly to the first neuron 23 of the circuit 40 shown in FIG. 4 (instead of the V-synapse 22), and by adding excitation V-synapses having a weight of wₑ/2 from the input+ and input− neurons 61, 62 to the last neuron 25 (instead of the V-synapse 24);
eliminating the output neuron 50 of the memory circuit 40, by sending the gₑ-synapse 52 directly to the output+ and output− neurons 81, 82 (instead of the V-synapses 79, 80); and
eliminating the recall neuron 48 of the memory circuit 40, by sending the V-synapses 73 and 74 directly to the output+ and output− neurons 81, 82 (instead of the V-synapse 49), and by adding excitation gₑ-synapses having the weight w_{acc} from the ready+ and ready− neurons 65, 66 to the acc neuron 44 of the circuit 40 (instead of the gₑ-synapse 51).

A.4. Synchroniser

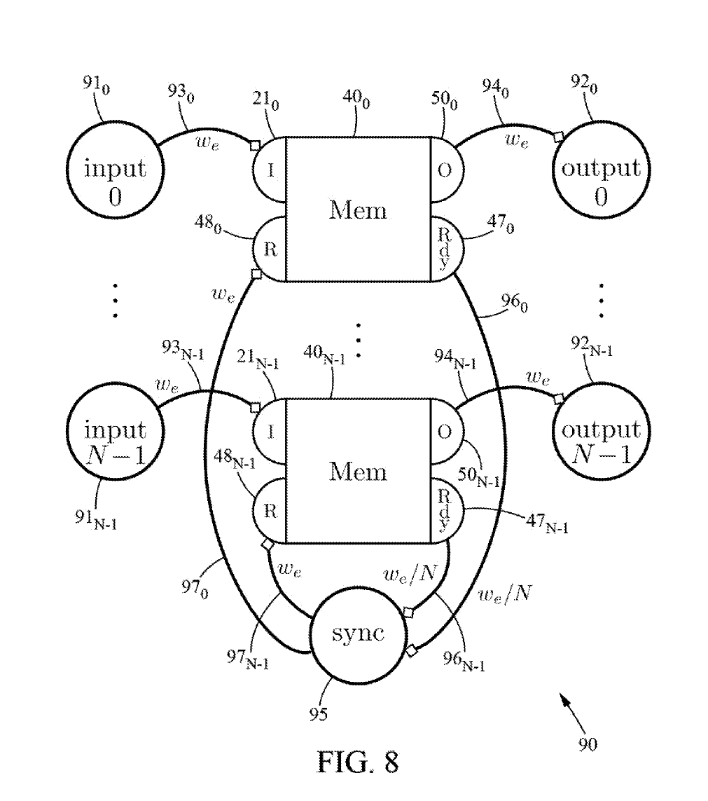

FIG. 8 shows a processing circuit 90 used to synchronise signals received on a number N of inputs (N≥2). All the synapses of this synchronisation circuit have the delay T_{syn}.

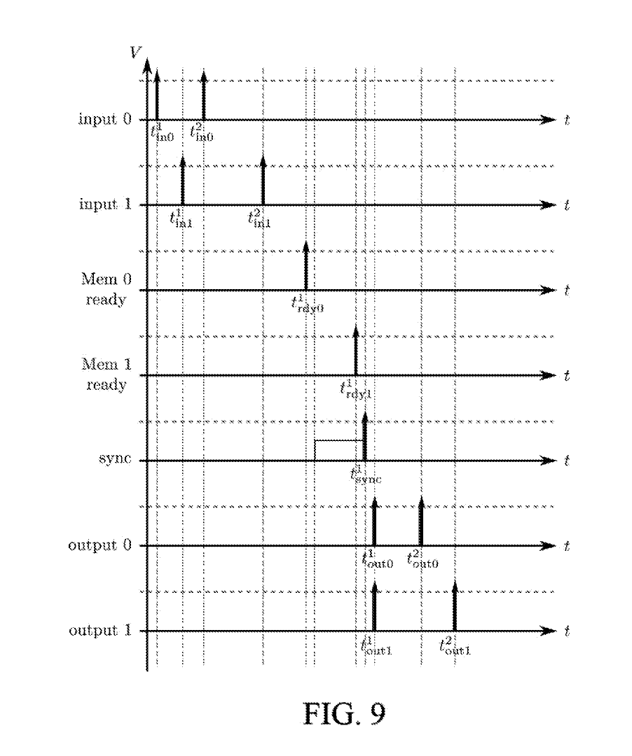

Each signal encodes a value xₖ for k=0, 1, . . . , N−1 and is in the form of a pair of spikes occurring at times tᵢₙₖ¹ andᵢₙₖ²=ᵢₙₖ¹+Δtₖ with Δtₖ=ƒ(xₖ)∈[Tₘᵢₙ, Tₘₐₓ]. These signals are returned at the output of the circuit 90 in a synchronised manner, i.e. each signal encoding a value xₖ is found at the output in the form of a pair of spikes occurring at times tₒᵤₜₖ¹ and tₒᵤₜₖ²=tₒᵤₜₖ¹+Δtₖ with tₒᵤₜ₀¹=tₒᵤₜ₁¹= . . . =t_{outN-1}¹, as shown in FIG. 9 for a case where N=2.

The circuit 90 shown in FIG. 8 comprises N neurons input 91₀, . . . , 91_{N-1} and N neurons output 92₀, . . . , 92_{N-1}. Each input neuron 91ₖ is the emitter node of a V-synapse 93ₖ having the weight wₑ, the receiver node of which is the input neuron 21ₖ of a respective memory circuit 40ₖ. The output neuron 50ₖ of each memory circuit 40ₖ is the emitter node of a V-synapse 94ₖ having the weight wₑ, the receiver node of which is the output neuron 92ₖ of the synchronisation circuit 90.

The synchronisation circuit 90 comprises a sync neuron 95 that is the receiver node of N excitation V-synapses 96₀, . . . , 96_{N-1} having a weight of wₑ/N, the emitter nodes of which are, respectively, the ready neurons 47₀, . . . , 47_{N-1} of the memory circuits 40₀, . . . , 40_{N-1}. The circuit 90 also comprises excitation V-synapses 97₀, . . . , 97_{N-1} having the weight wₑ, the sync neuron 95 as an emitter node, and, respectively, the recall neurons 48₀, . . . , 48_{N-1} of the memory circuits 40₀, . . . , 40_{N-1} as receiver nodes.

The sync neuron 95 receives the events produced by the ready neurons 47₀, . . . , 47_{N-1} as the N input signals are loaded into the memory circuits 40₀, . . . , 40_{N-1}, i.e. at times t_{ridy0}¹, t_{rdy1}¹ in FIG. 9. When the last of these N events has been received, the sync neuron 95 delivers an event T_{syn} later, i.e. at time t_{sync}¹ in FIG. 9. This triggers, via the synapses 97₀, . . . , 97_{N-1} and the synapses 49 of the memory circuits 40₀, . . . , 40_{N-1}, the emission of a first synchronised spike (tₒᵤₜ₀¹= . . . =t_{outN-1}¹) on each output neuron 92₀, . . . , 92_{N-1}. Then, each memory circuit 40ₖ produces its second respective spike at time tₒᵤₜₖ².

The presentation of the synchronisation circuit in reference to FIG. 8 is given to facilitate the explanation, but it should be noted that a plurality of simplifications are possible by eliminating certain neurons. For example, the input neurons 91₀, . . . , 91_{N-1} and the output neurons 92₀, . . . , 92_{N-1} are optional, since the inputs can be provided directly by the input neurons 21₀, . . . , 21_{N-1} of the memory circuits 40₀, . . . , 40_{N-1} and the outputs directly by the output neurons 50₀, . . . , 50_{N-1} of the memory circuits 40₀, . . . , 40_{N-1}. The V-synapses 46 of the memory circuit 40₀, . . . , 40_{N-1} can go directly to the sync neuron 95, without passing through a ready neuron 47₀, . . . , 47_{N-1}. The synapses 97₀, . . . , 97_{N-1} can be directly fed to the output neurons 50₀, . . . , 50_{N-1} of the memory circuits (thus replacing their synapses 49), and the sync neuron 95 can also form the emitter node of the gₑ-synapses 51 of the memory circuits 40₀, . . . , 40_{N-1} in order to control the restart of accumulation in the acc neurons 44 (FIGS. 4 and 5).

It is also possible to put out only a single event, at time tₒᵤₜ¹=tₒᵤₜ₀¹=tₒᵤₜ₁¹= . . . =t_{outN-1}¹, as the first event of all the pairs forming the synchronised output signals. The sync neuron 95 thus directly controls the emission of the first spike on a particular output of the circuit (which can be one of the output neurons 92₀, . . . , 92_{N-1} or a specific neuron), and then the second spike of each pair by reactivating the acc neurons 44 of the memory circuits 40₀, . . . , 40_{N-1} via a gₑ-synapse. In other words, the sync neuron 95 acts as the recall neurons 48 of the various memory circuits.

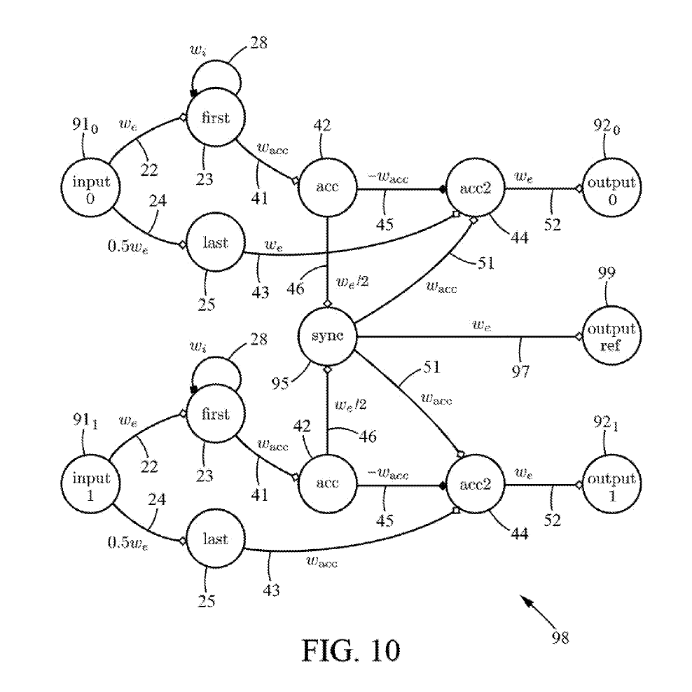

Such a synchroniser circuit 98 is illustrated for the case where N=2 by FIG. 10, where, once again, all the synapses have the delay T_{syn}. The sync neuron 95 is excited by two V-synapses 46 having a weight of wₑ/2 coming directly from the acc neurons 42 of the two memory circuits, and it is the emitter node of the gₑ-synapses 51 in order to restart the accumulation in the acc neurons 44. In this example, a specific neuron 99, noted as ‘output ref’, delivers the first event of each of the two output pairs at time tₒᵤₜ¹=t_{sync}¹+T_{syn}, in response to an excitation received from the sync neuron 95 via the V-synapse 97. The role of this output ref neuron 99 could, alternatively, be played by one of the two output neurons 92₀, 92₁.

It should be noted that in the example of FIG. 10, the two events encoding the value of an output value of the circuit 98 are produced by two different neurons (for example the neurons 99 and 92₁ for the value x₁).

More generally, in the context of the present invention, it is not necessary for the two events of a pair representing a value to come from a single node (in the case of an output value) or to be received by a single node (in the case of an input value).

### B. Logical Operations

B.1. Minimum

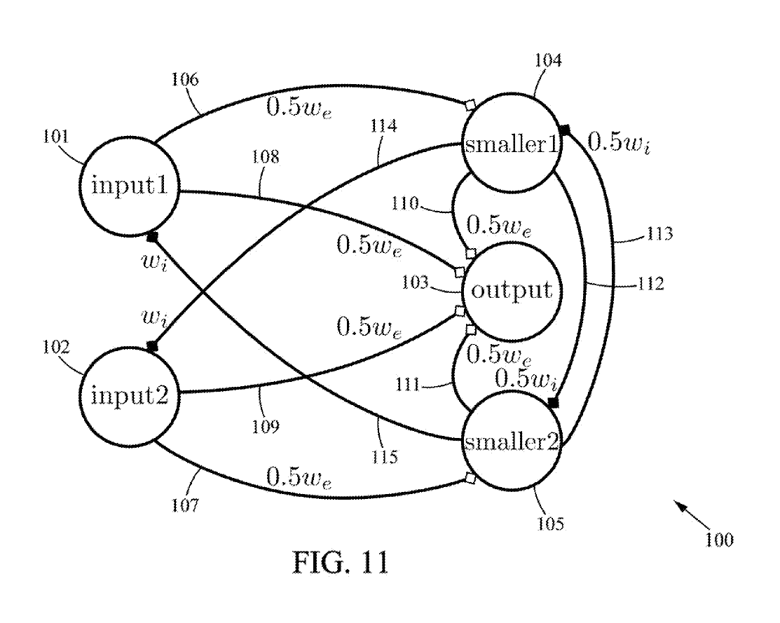

FIG. 11 shows a processing circuit 100 that calculates the minimum between two values received in a synchronised manner on two input nodes 101, 102 and delivers this minimum on an output node 103.

Besides the input neurons 101, 102 and the output neuron 103, this circuit 100 comprises two ‘smaller’ neurons 104, 105. An excitation V-synapse 106, having a weight of wₑ/2, goes from the input neuron 101 to the smaller neuron 104. An excitation V-synapse 107, having a weight of wₑ/2, goes from the input neuron 102 to the smaller neuron 105. An excitation V-synapse 108, having a weight of wₑ/2, goes from the input neuron 101 to the output neuron 103. An excitation V-synapse 109, having a weight of wₑ/2, goes from the input neuron 102 to the output neuron 103. An excitation V-synapse 110, having a weight of wₑ/2, goes from the smaller neuron 104 to the output neuron 103. An excitation V-synapse 111, having a weight of wₑ/2, goes from the smaller neuron 105 to the output neuron 103. An inhibiting V-synapse 112, having a weight of wᵢ/2, goes from the smaller neuron 104 to the smaller neuron 105. An inhibiting V-synapse 113, having a weight of wᵢ/2, goes from the smaller neuron 105 to the smaller neuron 104. An inhibiting V-synapse 114, having the weight wᵢ, goes from the smaller neuron 104 to the input neuron 102. An inhibiting V-synapse 115, having the weight wᵢ, goes from the smaller neuron 105 to the input neuron 101. All the synapses 106-115 shown in FIG. 11 are associated with a delay T_{syn}, except the synapses 108, 109 for which the delay is 2·T_{syn}+Tₙₑᵤ.

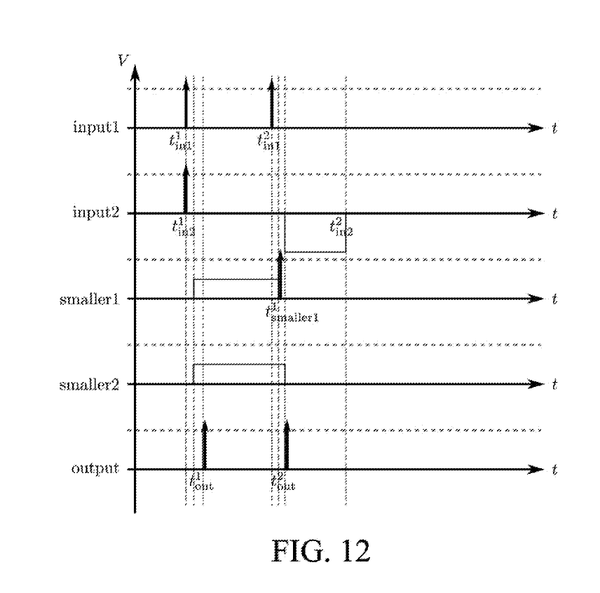

The emission of the first spike on each input neuron 101, 102 at time tᵢₙ₁¹=tᵢₙ₂¹ (FIG. 12) sets each of the smaller neurons 104, 105 to a potential value Vₜ/2 at time tᵢₙ₁¹+T_{syn}, and triggers a first event on the output neuron 103 at time tₒᵤₜ¹=tᵢₙ₁¹+2·T_{syn}+2·Tₙₑᵤ. The emission of the second spike on the input neuron having the smallest value, namely the neuron 101 at time tᵢₙ₁²=tᵢₙ₁¹+Δt₁ in the example of FIG. 12, sets one of the smaller neurons to the threshold voltage Vₜ, namely the neuron 104 in this example, which leads to an event at time tₛₘₐₗₗₑᵣ₁²=tᵢₙ₁²+T_{syn}+Tₙₑᵤ at the output of this neuron 104. Thus, the synapse 114 inhibits the other input neuron 102, which does not produce its second spike at time tᵢₙ₂²=tᵢₙ₂¹+Δt₂, and the synapse 112 inhibits the other smaller neuron 105, the potential of which is reset to zero. The triggering of the smaller neuron 104 further causes the second triggering of the output neuron 103 at time tₒᵤₜ₁²=tₛₘₐₗₗₑᵣ₁¹=t_{syn}+Tₙₑᵤ=tᵢₙ₁²+2·T_{syn}+2·Tₙₑᵤ.

Finally, the output neuron 103 does reproduce, between the events that it delivers, the minimum time interval tₒᵤₜ²−tₒᵤₜ¹=tᵢₙ₁²−tᵢₙ₁¹=Δt₁ between the events of the two pairs produced by the input neurons 101, 102. This minimum is available at the output of the circuit 100 upon reception of the second event of the pair that represents it at the input.

The circuit 100 for calculating a minimum of FIG. 11 functions when the function ƒ such that Δt=ƒ(x) is an increasing function.

B.2. Maximum

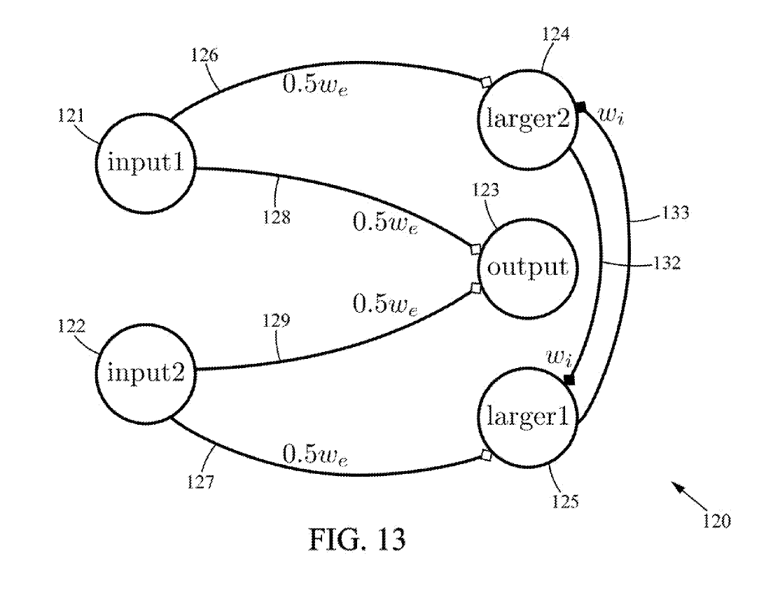

FIG. 13 shows a processing circuit 120 that calculates the maximum between two values received in a synchronised manner on two input nodes 121, 122 and delivers this maximum on an output node 123.

Besides the input neurons 121, 122 and the output neuron 123, this circuit 120 comprises two ‘larger’ neurons 124, 125. An excitation V-synapse 126, having a weight of wₑ/2, goes from the input neuron 121 to the larger neuron 124. An excitation V-synapse 127, having a weight of wₑ/2, goes from the input neuron 122 to the larger neuron 125. An excitation V-synapse 128, having a weight of wₑ/2, goes from the input neuron 121 to the output neuron 123. An excitation V-synapse 129, having a weight of wₑ/2, goes from the input neuron 122 to the output neuron 123. An inhibiting V-synapse 132, having the weight 142 goes from the larger neuron 124 to the larger neuron 125. An inhibiting V-synapse 133, having the weight 142 goes from the larger neuron 125 to the larger neuron 124. All the synapses shown in FIG. 13 are associated with the delay T_{syn}.

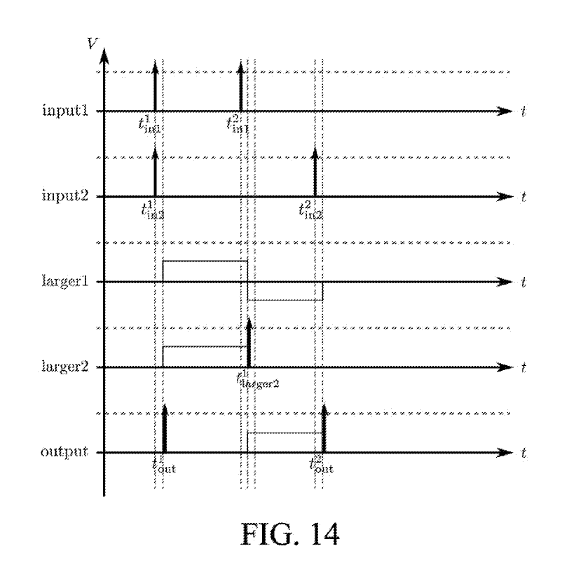

The first spikes emitted in a synchronised manner (tᵢₙ₁¹=tᵢₙ₂¹) by the input neurons 121, 122 set the larger neurons 124, 125 to a potential value Vₜ/2 at time tᵢₙ₁¹+T_{syn}, and trigger a first event on the output neuron 123 at time tₒᵤₜ¹=tᵢₙ₁¹+T_{syn}+Tₙₑᵤ, (FIG. 14). The emission of the second spike on the input neuron having the smallest value, namely the neuron 121 at time tᵢₙ₁²=tᵢₙ₁¹+Δt₁ in the example of FIG. 14, sets one of the larger neurons to the threshold voltage Vₜ, namely the neuron 124 in this example, which triggers an event at time t_{larger2}¹=tᵢₙ₁²+T_{syn}+Tₙₑᵤ at the output of this neuron 124. Thus, the synapse 132 inhibits the other larger neuron 125, the potential of which is set to the value Vₜ/2. When the second spike is emitted by the other input neuron 122 at time tᵢₙ₂²=tᵢₙ₂¹++Δt₂ (with Δt₂>Δt₁), the potential of the larger neuron 125 is reset to zero via the synapse 127, and the output neuron 123 is triggered via the synapse 129 at time tₒᵤₜ²=tᵢₙ₂²+T_{syn}+Tₙₑᵤ.

Finally, the output neuron 123 does reproduce, between the events that it delivers, the maximum time interval tₒᵤₜ²−tₒᵤₜ¹=tᵢₙ₂²−tᵢₙ₂¹=Δt₂ between the events of the two pairs produced by the input neurons 121, 122. This maximum is available at the output of the circuit 120 upon reception of the second event of the pair that represents it at the input.

The circuit 120 for calculating a maximum of FIG. 13 functions when the function ƒ such that Δt=ƒ(x) is an increasing function.

### C. Linear Operations

C.1. Subtraction

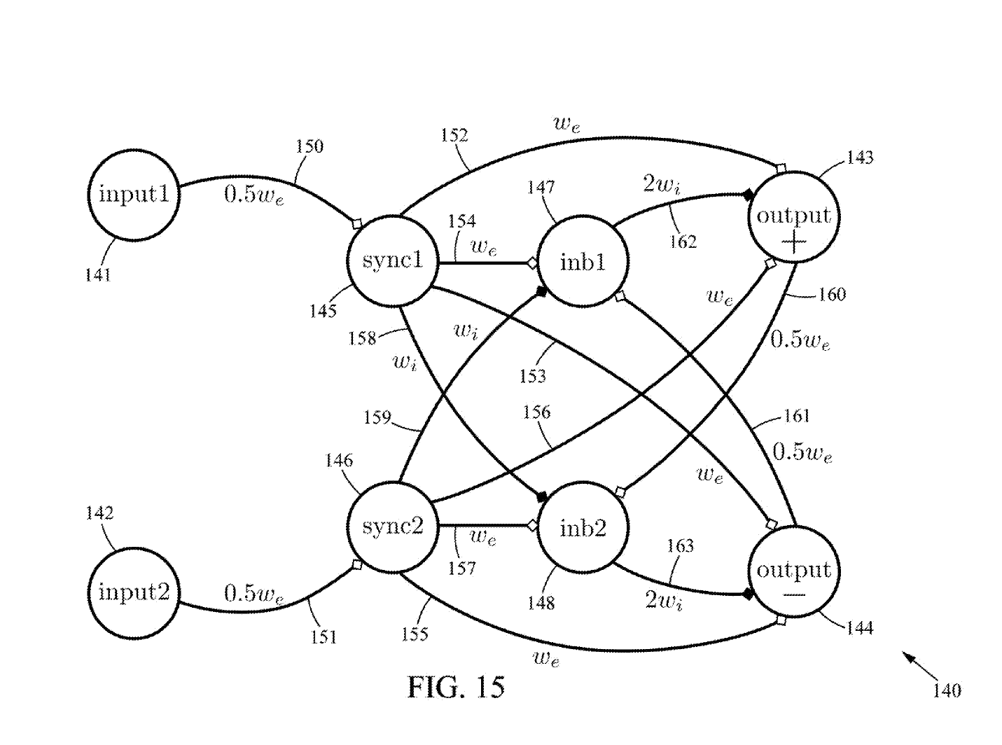

FIG. 15 shows a subtraction circuit 140 that calculates the difference between two values x₁, x₂ received in a synchronised manner on two input nodes 141, 142 and delivers the result x₁−x₂ on an output node 143 if it is positive and on another output node 144 if it is negative. It is assumed here that the function ƒ such that Δt₁=ƒ(x₁) and Δt₂=ƒ(x₂) is a linear function, as is the case for the form (11).

Besides the input neurons 141, 142 and the neurons output+ 143 and output− 144, the subtraction circuit 140 comprises two sync neurons 145, 146 and two ‘inb’ neurons 147, 148. An excitation V-synapse 150, having a weight of wₑ/2, goes from the input neuron 141 to the sync neuron 145. An excitation V-synapse 151, having a weight of wₑ/2, goes from the input neuron 142 to the sync neuron 146. Three excitation V-synapses 152, 153, 154, each having the weight of wₑ, go from the sync neuron 145 to the output+ neuron 143, to the output− neuron 144 and to the inb neuron 147, respectively. Three excitation V-synapses 155, 156, 157, each having the weight wₑ, go from the sync neuron 146 to the output− neuron 144, to the output+ neuron 143 and to the inb neuron 148, respectively. An inhibiting V-synapse 158, having the weight iv goes from the sync neuron 145 to the inb neuron 148. An inhibiting V-synapse 159, having the weight wᵢ goes from the sync neuron 146 to the inb neuron 147. An excitation V-synapse 160, having a weight of wₑ/2, goes from the output+ neuron 143 to the inb neuron 148. An excitation V-synapse 161, having a weight of wₑ/2, goes from the output− neuron 144 to the inb neuron 147. An inhibiting V-synapse 162, having a weight of 2wᵢ, goes from the inb neuron 147 to the output+ neuron 143. An inhibiting V-synapse 163, having a weight of 2wᵢ, goes from the inb neuron 163 to the output− neuron 144. The synapses 150, 151, 154 and 157-163 are associated with a delay of T_{syn}. The synapses 152 and 155 are associated with a delay of Tₘᵢₙ+3·T_{syn}+2·Tₙₑᵤ. The synapses 153 and 156 are associated with a delay of 3·T_{syn}+2·Tₙₑᵤ.

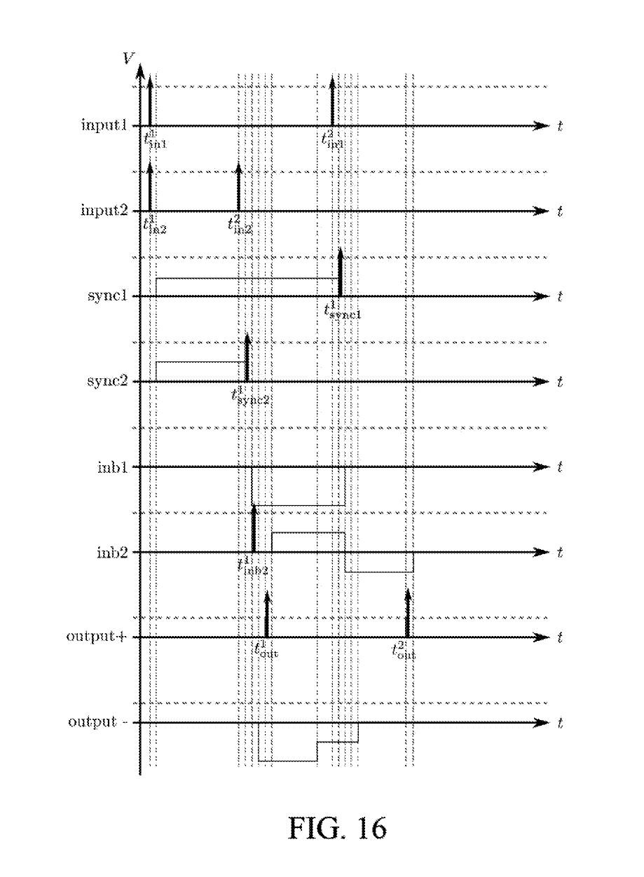

The operation of the subtraction circuit 140 according to FIG. 15 is illustrated by FIG. 16 for the case in which the result x₁-x₂ is positive. Everything happens symmetrically if the result is negative.

The first spikes emitted in a synchronised manner (tᵢₙ₁¹=tᵢₙ₂¹) by the input neurons 141, 142 set the sync neurons 145, 146 to the potential value Vₜ/2 at time tᵢₙ₁¹+T_{syn}. The emission of the second spike on the input neuron providing the smallest value, namely the neuron 142 at time tᵢₙ₂²=tᵢₙ₂¹+Δt₂ in the example of FIG. 16 where Δt₂<Δt₁, sets one of the sync neurons to the threshold voltage Vₜ, namely the neuron 146 in this example, which triggers an event at time t_{sync2}¹=tᵢₙ₂²+T_{syn}+Tₙₑᵤ at the output of this neuron 146. Thus:
the synapse 159 inhibits the inb neuron 147, the potential of which is set to the value −Vₜ at time t_{sync2}¹+T_{syn}=tᵢₙ₂²++2·T_{syn}+Tₙₑᵤ;
the synapse 157 excites the inb neuron 148 that delivers an event at time t_{inb2}¹=t_{sync2}¹+T_{syn} Tₙₑᵤ=tᵢₙ₂²+2·T_{syn}+2·Tₙₑᵤ, which event in turn inhibits, via the synapse 163, the output− neuron 144, the potential of which is set to the value −2Vₜ at time tᵢₙ₂²+3·T_{syn}+2·Tₙₑᵤ;
the synapse 155 then re-excites the output− neuron 144, the potential of which is set to the value −Vₜ at time tᵢₙ₂²+Tₘᵢₙ+4·T_{syn}+3·Tₙₑᵤ;
the synapse 156 excites the output+ neuron 143 that delivers an event at time tₒᵤₜ¹=t_{sync2}¹+3·T_{syn}+3·Tₙₑᵤ=tᵢₙ₂²+4·T_{syn}+4·Tₙₑᵤ, which event in turn excites the inb neuron 148, the potential of which, reset to zero after the previous event emitted at time t_{inb2}¹, is set to the value Vₜ/2 at time tₒᵤₜ¹+T_{syn}+Tₙₑᵤ=tᵢₙ₂²+5·T_{syn}+5·Tₙₑᵤ.

Then, emission of a second spike on the other input neuron 141 at time tᵢₙ₁²=tᵢₙ₁¹+Δt₁ sets the other sync neuron 145 to the threshold voltage Vₜ, which triggers an event at time t_{sync1}¹=tᵢₙ₁²+T_{syn}+Tₙₑᵤ at the output of this neuron 145. Thus:
the synapse 158 inhibits the inb neuron 148, the potential of which is set to the value −Vₜ/2 at time t_{sync1}¹+T_{syn}=tᵢₙ₁²+2·T_{syn}+Tₙₑᵤ;
the synapse 154 excites the inb neuron 147 that resets its membrane potential to zero;
the synapse 152 excites the output+ neuron 143 that delivers an event at time tₒᵤₜ²=t_{sync1}¹+Tₘᵢₙ+3·T_{syn}+3·Tₙₑᵤ=tᵢₙ₁²+Tₘᵢₙ+4·T_{syn}+4·Tₙₑᵤ, which event in turn excites the inb neuron 148, the potential of which is reset to zero at time tₒᵤₜ²+T_{syn}+Tₙₑᵤ=tᵢₙ₁²+Tₘᵢₙ+5·T_{syn}+5·Tₙₑᵤ;
the synapse 153 excites the output− neuron 144, the potential of which is reset to zero at time t_{sync1}¹+3·T_{syn}+2·Tₙₑᵤ=tᵢₙ₁²+4·T_{syn}+3·Tₙₑᵤ.

The two excitation events received by the output− neuron 144, at times tᵢₙ₂²+Tₘᵢₙ+4·T_{syn}+3·Tₙₑᵤ and tᵢₙ₁²+4·T_{syn}+3·Tₙₑᵤ are after the inhibiting event received at time tᵢₙ₂²+3·T_{syn}+2·Tₙₑᵤ. As a result, this neuron 144 does not emit any event when Δt₂<Δt₁, and thus the sign of the result is suitably signalled.

Finally, the output+ neuron 143 delivers two events having between them a time interval Δtₒᵤₜ between the events of the two pairs produced by the input neurons 141, 142, with:

$$\begin{matrix}Δ {t}_{out} = ( {t}_{in 1}^{2} + {T}_{min} + 4 \cdot {T}_{syn} + 4 \cdot {T}_{neu} ) - \\ ( {t}_{in 2}^{2} + 4 \cdot {T}_{syn} + 4 \cdot {T}_{neu} ) \\ = Δ {t}_{1} - Δ {t}_{2} + {T}_{min} \\ = {T}_{min} + ( {x}_{1} - {x}_{2} ) \cdot {T}_{cod}\end{matrix} \qquad ( 15 )$$

Over the output neuron having the correct sign at the output of the subtractor circuit 140, two events are properly obtained having between them the time interval Δtₒᵤₜ=ƒ(x₁-x₂). This result is available at the output of the circuit upon reception of the second event of the input pair having the greatest absolute value.

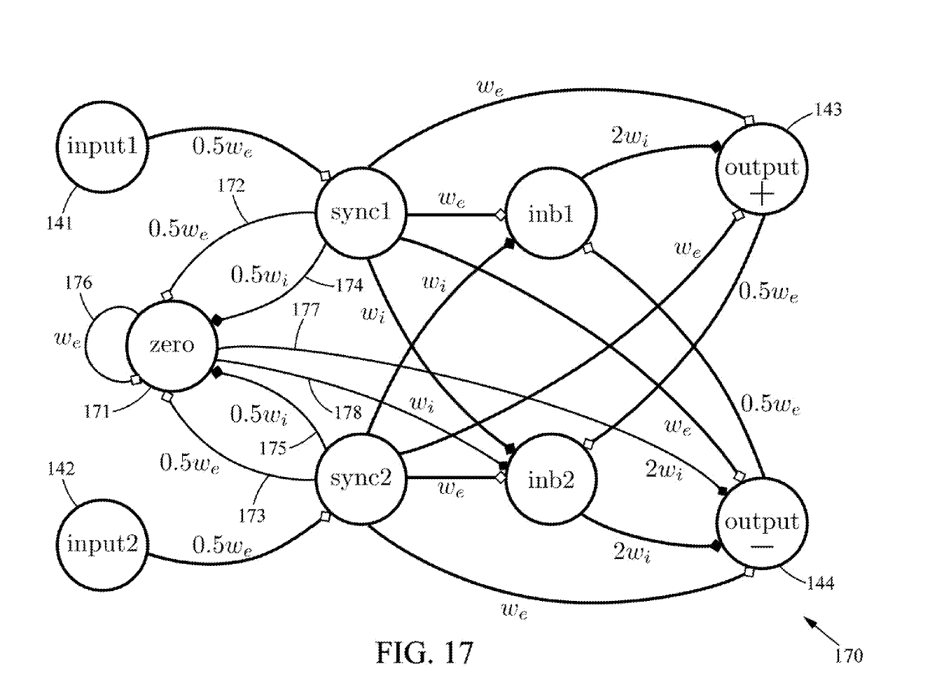

When two equal values are presented to it at the input, the subtractor circuit 140 shown in FIG. 15 activates the two parallel paths and the result is delivered on both the output+ neuron 143 and the output− neuron 144, the inb neurons 147, 148 not having the time to select a winning path. In order to avoid this, it is possible to add, to the subtractor circuit, a zero neuron 171 and fast V-synapses 172-178 in order to form a subtractor circuit 170 according to FIG. 17.

In FIG. 17, the reference numerals of the neurons and synapses arranged in the same way as in FIG. 15 are not repeated. The zero neuron 171 is the receiver node of two excitation V-synapses 172, 173 having a weight of wₑ/2 and the delay Tₙₑᵤ, one coming from the sync neuron 145 and the other from the sync neuron 146. It is also the receiver node of two inhibiting V-synapses 174, 175 having a weight of wₑ/2 and a delay of 2·Tₙₑᵤ, one coming from the sync neuron 145 and the other from the sync neuron 146. The zero neuron 171 excites itself via a V-synapse 176 having the weight wₑ and the delay Tₙₑᵤ. It is also the emitter node of two inhibiting V-synapses having the delay Tₙₑᵤ, one 177 having the weight wᵢ directed towards the inb neuron 148 and the other 178 having a weight of 2wᵢ directed towards the output− neuron 144.

The zero neuron 171 acts as a detector of coincidence between the events delivered by the sync neurons 145, 146. Given that these two neurons only deliver events at the time of the second encoding spike of their associated input, detecting this temporal coincidence is equivalent to detecting the equality of the two input values, if the latter are correctly synchronised. The zero neuron 171 only produces an event if it receives two events separated by a time interval less than Tₙₑᵤ from the sync neurons 145, 146. In this case, it directly inhibits the output− neuron 144 via the synapse 178, and deactivates the inb neuron 148 via the synapse 177.

Consequently, two equal input values provided to the subtractor circuit of FIG. 17 lead to two events separated by a time interval equal to Tₘᵢₙ, i.e. encoding a difference of zero, at the output of the output+ neuron 143, and to no event on the output− neuron 144. If the input values are not equal, the zero neuron 171 is not activated and the subtractor functions in the same manner as that of FIG. 15.

C.2. Accumulation

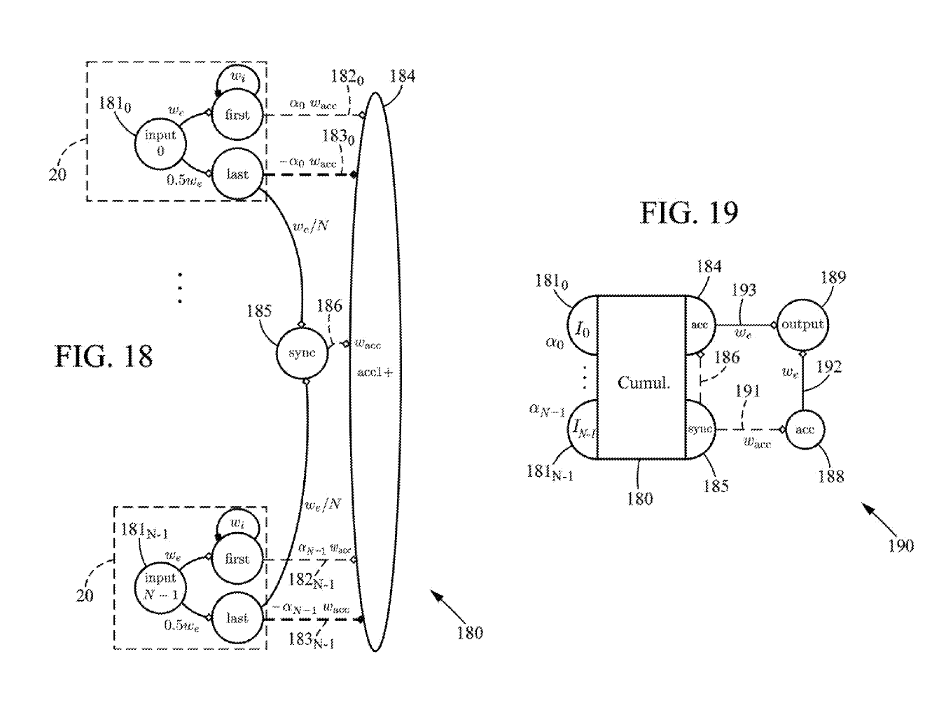

FIG. 18 shows a circuit 180 for accumulating positive input values with weighting. Its goal is to load, into a acc neuron 184, a potential value related to a weighted sum:

S=Σₖ₌₀^{N-1}αₖ·xₖ (16)

where α₀, α₁, . . . , α_{N-1} are positive or zero weighting coefficients and the input values x₀, x₁, . . . , x_{N-1} are positive or zero.

For each input value xₖ (0≤k<N), the circuit 180 comprises a input neuron 181ₖ and an input− neuron 182ₖ each part of a respective group 20 of neurons arranged in the same way as in the group 20 described above in reference to FIG. 2.

The outgoing connections of the first and last neurons of these N groups of neurons 20 are configured as a function of the coefficients αₖ of the weighted sum to be calculated.

The first neuron connected to the input neuron 181ₖ (0≤k<N) is the emitter node of an excitation gₑ-synapse 182ₖ having a weight of αₖ, w_{acc} and a delay of Tₘᵢₙ+T_{syn}. The last neuron connected to the input neuron 181ₖ is the emitter node of an inhibiting gₑ-synapse 183ₖ having a weight of −αₖ·w_{acc} and the delay T_{syn}.

The acc neuron 184 accumulates the terms αₖ·xₖ. Thus, for each input k, the acc neuron 184 is the receiver node of the excitation gₑ-synapse 182ₖ and of the inhibiting gₑ-synapse 183ₖ.

The circuit 180 further comprises a sync neuron 185 that is the receiver node of N V-synapses, each having a weight of wₑ/N and the delay T_{syn}, respectively coming from the last neurons connected to the N neurons input 181ₖ (0≤k<N). The sync neuron 185 is the emitter node of an excitation gₑ-synapse 186 having the weight w_{acc} and the delay T_{syn}, the receiver node of which is the acc neuron 184.

For each input having two spikes separated by Δtₖ=Tₘᵢₙ+xₖ·T_{cod} on the input neuron 181ₖ, the acc neuron 184 integrates the quantity αₖ·Vₜ/Tₘₐₓ over a duration Δtₖ−Tₘᵢₙ xₖ·T_{cod}.

Once all the second spikes of the k input signals have been received, the sync neuron 185 is triggered and excites the acc neuron 184 via the gₑ-synapse 186. The potential of the acc neuron 184 continues to grow for a residual time equal to Tₘₐₓ−Σₖ₌₀^{N-1}αₖ·xₖ·T_{cod}. At this time, the threshold Vₜ is reached by the acc neuron 184 that triggers an event.

The delay of this event with respect to that delivered by the sync neuron 185 is Tₘₐₓ|Σₖ₌₀^{N-1}αₖ·xₖ·T_{cod}=ƒ(1−Σₖ₌₀^{N-1}αₖ·xₖ)=ƒ(1−s). The weighted sums is only made accessible by the circuit 180 in its inverted form (1−s).

The circuit 180 functions in the way that was just described under the condition that T_{cod}·Σₖ₌₀^{N-1}αₖ·xₖ<Tₘₐₓ. The coefficients αk can be normalised in order for this condition to be met for all the possible values of the xk, i.e. such that

$$\frac{{T}_{max}}{{T}_{cod}} .$$

C.3. Weighted Sum

A weighted addition circuit 190 can have the structure shown in FIG. 19.

In order to obtain the representation of the weighted sum s according to (16), a circuit 180 for weighted accumulation of the type of that described in reference to FIG. 18 is associated with another acc neuron 188 and with an output neuron 189.

The acc neuron 188 is the receiver node of an excitation gₑ-synapse 191 having the weight w_{acc} and the delay T_{syn}, and the emitter node of an excitation V-synapse 192 having the weight wₑ and a delay of Tₘᵢₙ+T_{syn}. The output neuron 189 is also the receiver node of an excitation V-synapse 193 having the weight wₑ and the delay T_{syn}.

The linearly changing accumulation starts in the acc neuron 188 at the same time as it restarts in the acc neuron 184 of the circuit 180, the two acc neurons 184, 188 being excited on the gₑ-synapses 186, 191 by the same event coming from the sync neuron 185. Their residual accumulation times, until the threshold Vₜ is reached, are, respectively, Tₘₐₓ−Σₖ₌₀^{N-1}αₖ·xₖ·T_{cod} and Tₘₐₓ. Because the synapse 192 has a relative delay of Tₘᵢₙ, the two events triggered on the output neuron 189 have between them the time interval Tₘᵢₙ+Σₖ₌₀^{N-1}αₖ·xₖ·T_{cod}=ƒ(s).

The expected weighted sum is represented at the output of the circuit 190. When N=2 and α₀=α₁=½, this circuit 190 becomes a simple adder circuit, with a scale factor of ½ in order to avoid overflows in the acc neuron 184.

C.4. Linear Combination

The more general case of linear combination is also expressed by equation (16) above, but the coefficients αₖ can be positive or negative, just like the input values xₖ. Without losing generality, the coefficients and input values are ordered in such a way that the coefficients α₀, α₁, . . . , α_{M-1} are positive or zero and the coefficients α_{M+1}, α_{M+2}, . . . , α_{N-1} are negative (N≥2, M≥0, N−M≥0).

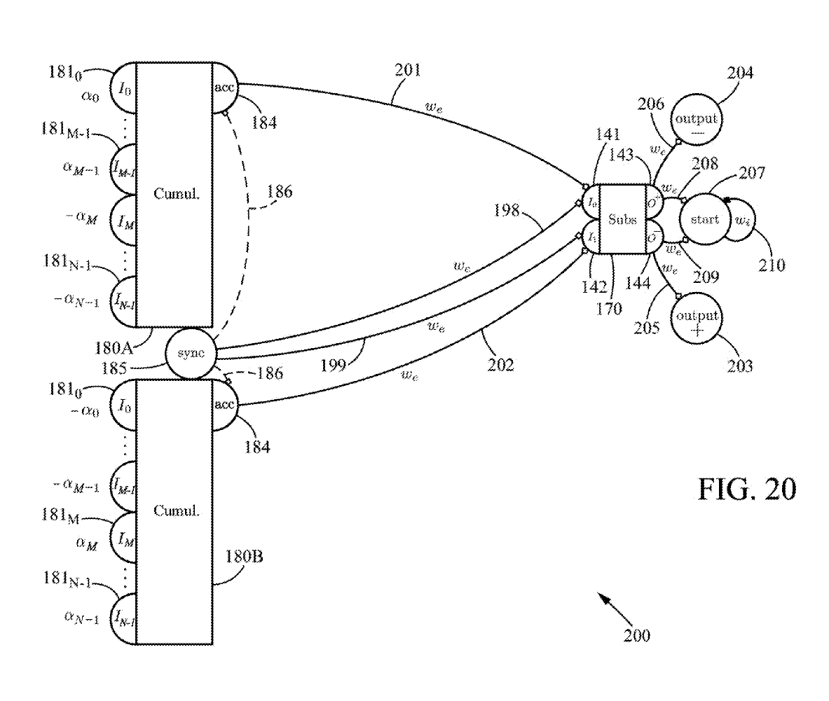

In order to take into account the positive or negative values, the circuit 200 for calculating a linear combination shown in FIG. 20 comprises two accumulation circuits 180A, 180B of the type of that described in reference to FIG. 18.

The input neurons 181ₖ of the accumulation circuit 180A are respectively associated with the coefficients αₖ for 0≤k<M and with the inverted coefficients −αₖ for M≤k<N. These input neurons 181ₖ for 0≤k<M receive a pair of spikes representing xₖ when xₖ≥0 and thus form neurons of the input+ type for these values x₀, . . . , x_{M-1}. The input neurons 181ₖ of the circuit 180A for M≤k<N receive a pair of spikes representing xₖ when xₖ<0 and thus form neurons of the input− type for these values x_{M}, . . . , x_{N-1}.

The input neurons 181ₖ of the circuit 180B for weighted accumulation are respectively associated with the inverted coefficients −αₖ for 0≤k<M and with the coefficients αₖ for M≤k<N. These input neurons 181ₖ for 0≤k<M receive a pair of spikes representing xₖ when xₖ<0 and thus form neurons of the input− type for these values x₀, . . . , x_{M-1}. The neurons input 181ₖ of the circuit 180B for M≤k<N receive a pair of spikes representing xₖ when xₖ≥0 and thus form neurons of the input+ type for these values x_{M}, . . . , x_{N-1}.

The two accumulation circuits 180A, 180B share their sync neuron 185 that is thus the receiver node of 2N V-synapses, each having a weight of wₑ/N and the delay T_{syn}, coming from last neurons coupled with the 2N input neurons 181ₖ. The sync neuron 185 of the linear combination calculation circuit 200 is therefore triggered once the N input values x₀, . . . , x_{N-1}, positive or negative, have been received on the neurons 181ₖ.

A time ΔT_{A}=Tₘₐₓ|E_{α}_{ₖ}_{·x}_{ₖ}_{≥0}|αₖ·xₖ|·T_{cod}=ƒ (1−Σ_{α}_{ₖ}_{·x}_{ₖ}_{≥0}|αₖ·xₖ|) elapses between the respective events delivered by the sync neuron 185 and the acc neuron 184 of the circuit 180A.

A time ΔT_{B}=Tₘₐₓ−Σ_{α}_{ₖ}_{·x}_{ₖ}_{<0}|αₖ·xₖ|·T_{cod}=ƒ (1−Σ_{α}_{ₖ}_{·x}_{ₖ}_{<0}|αₖ·xₖ|) elapses between the respective events delivered by the sync neuron 185 and the acc neuron 184 of the circuit 180B.

A subtractor circuit 170 that can be of the type of that shown in FIG. 17 then combines the time intervals ΔT_{A} and ΔT_{B} in order to produce the representation of |s|=Σ_{α}_{ₖ}_{·x}_{ₖ}_{≥0}|Σ_{α}_{ₖ}_{·x}_{ₖ}_{<0}| on an output indicative of the sign of s. For this, the linear combination calculation circuit 200 of FIG. 20 comprises two excitation V-synapses 198, 199, having the weight wₑ and a delay of Tₘᵢₙ+T_{syn}, directed towards the input neurons 141, 142 of the subtractor circuit 170. Moreover, an excitation V-synapse 201 having the weight wₑ and the delay T_{syn} goes from the acc neuron 184 of the circuit 180A to the input neuron 141 of the subtractor circuit 170. An excitation V-synapse 202 having the weight wₑ and the delay T_{syn} goes from the acc neuron 184 of the circuit 180B to the other input neuron 142 of the subtractor circuit 170.

The output− neuron 144 and the output+ neuron 143 of the subtractor circuit 170 are respectively connected, via excitation V-synapses 205, 206 having the weight wₑ and the delay T_{syn}, to two other output+ and output− neurons 203, 204 that form the outputs of the circuit 200 for calculating a linear combination.

The one of these two neurons that is triggered indicates the sign of the result s of the linear combination. It delivers a pair of events separated by the time interval Δtₒᵤₜ=Tₘᵢₙ+ΔT_{A}−ΔT_{B}=ƒ(|Σ_{α}_{ₖ}_{·x}_{ₖ}_{≥0}|αₖ·xₖ|−Σ_{α}_{ₖ}_{·x}_{ₖ}_{<0}|αₖ·xₖ∥)=ƒ(|s|).

The availability of this result is indicated on the outside by a ‘start’ neuron 207 receiving two excitation V-synapses 208, 209, having the weight wₑ and the delay T_{syn}, coming from the output+ neuron 143 and the output− neuron 144 of the subtractor circuit 170. The start neuron 207 inhibits itself via a V-synapse 210, having the weight wᵢ and the delay T_{syn}. The start neuron 207 delivers a spike simultaneously to the first spike of the output+ or output− neuron 203, 204 which is activated.

The coefficients αₖ can be normalised in order for the conditions Σ_{α}_{ₖ}_{·x}_{ₖ}_{≥0}|αₖ·xₖ|·T_{cod}<Tₘₐₓ and Σ_{α}_{ₖ}_{·x}_{ₖ}_{<0}|αₖ·xₖ|·T_{cod}<Tₘₐₓ to be met for all the possible values of the xₖ, i.e. in such a way that

$${\sum }_{k = 0}^{N - 1} \vert {α}_{k} \vert < \frac{{T}_{max}}{{T}_{cod}} ,$$

in order for the circuit 200 for calculating a linear combination to function as described above. The normalisation factor must therefore be taken into account in the result.

### D. Nonlinear Operations

D.1. Logarithm

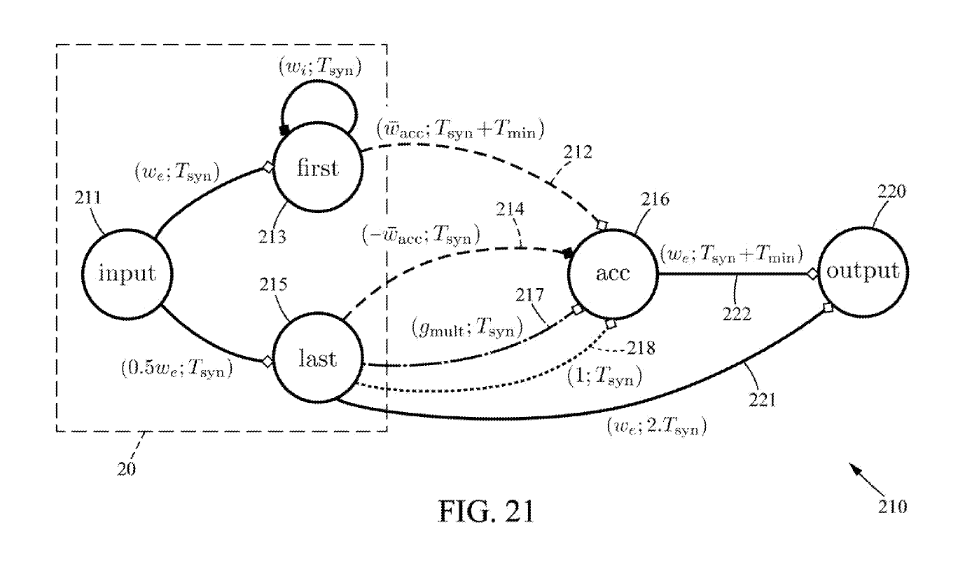

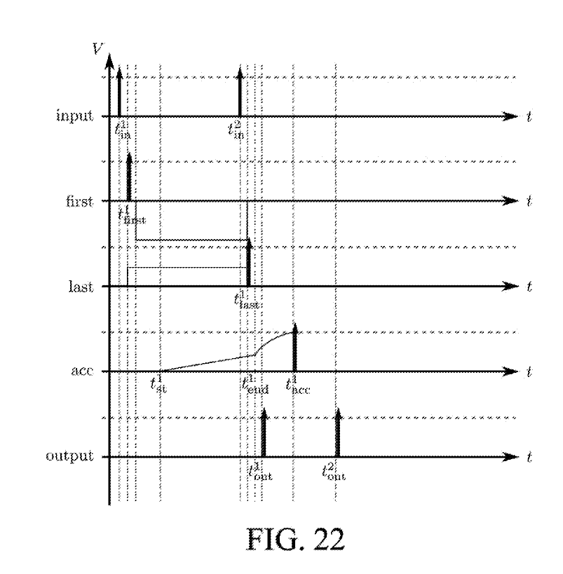

FIG. 21 shows a circuit 210 for calculating the natural logarithm of a number x∈]0, 1], an encoded representation of which is produced by a input neuron 211 in the form of two events occurring at times tᵢₙ¹ and tᵢₙ²=tᵢₙ¹+Δt (FIG. 22) with Δt=ƒ(x)=Tₘᵢₙ+x·T_{cod}.

The input neuron 211 belongs to a group of nodes 20 similar to that described in reference to FIG. 2. The first neuron 213 of this group 20 is the emitter node of an excitation ge-synapse 212 having the weight w̅_{acc} and a delay of Tmin+Tsyn, while the last neuron 215 is the emitter node of an inhibiting ge-synapse 214 having a weight of −w̅_{acc} and the delay Tsyn. The two ge-synapses 212, 214 have the same acc neuron 216 as a receiver node. From the last neuron 215 to the acc neuron 216, there is also a gf-synapse 217 having the weight

$${g}_{mult} = {V}_{t} \cdot \frac{{τ}_{m}}{{τ}_{f}}$$

and a gate-synapse 218 having a weight of 1 and the delay Tsyn.

The circuit 210 further comprises an output neuron 220 that is the receiver node of an excitation V-synapse 221 having the weight wₑ and a delay of 2·T_{syn} coming from the last neuron 215, and of an excitation V-synapse 222 having the weight wₑ and a delay of Tₘᵢₙ+T_{syn} coming from the acc neuron 216.

The operation of the logarithm calculation circuit 210 according to FIG. 21 is illustrated by FIG. 22.

The emission of the first spike at time tᵢₙ¹ at the input neuron 211 triggers an event at the output of the first neuron 213 at time t_{first}¹=tᵢₙ¹+T_{syn} Tₙₑᵤ. The first neuron 213 starts the accumulation by the acc neuron 216 at time tₛₜ¹=tᵢₙ¹+Tₘᵢₙ+2·T_{syn}+Tₙₑᵤ via the gₑ-synapse 212.

The emission of the second spike at time tᵢₙ²=tᵢₙ¹+Tₘᵢₙ+x·T_{cod} at the input neuron 211 causes the last neuron 215 to deliver an event at time tₗₐₛₜ¹=tᵢₙ²+T_{syn}+Tₙₑᵤ. This event transported by the gₑ-synapse 214 stops the accumulation carried out by the acc neuron 216 at time t_{end}¹=tₗₐₛₜ¹+T_{syn}=tₛₜ¹+x·T_{cod}. At this time, the potential value Vₜ·x is stored in the acc neuron 216.

Via the synapses 217 and 218, the last neuron 215 further activates the exponential change on the acc neuron 216 at the same time t_{end}¹ via the g_{ƒ}-synapse 217 and the gate-synapse 218. It should be noted that alternatively, the event transported by the g_{ƒ}-synapse 217 could also arrive later at the acc neuron 216 if it is desired to store, in the latter, the potential value Vₜ·x while other operations are carried out in the device.

After activation by the synapses 217 and 218, the component g_{ƒ} of the acc neuron 216 changes according to:

$${g}_{f} ( t ) = {V}_{t} \cdot \frac{{τ}_{m}}{{τ}_{f}} \cdot {e}^{- \frac{t - {t}_{end}^{1}}{{τ}_{f}}} \qquad ( 17 )$$

and its membrane potential according to:

$$V ( t ) = {V}_{t} \cdot ( 1 + x - {e}^{- \frac{t - {t}_{end}^{1}}{{τ}_{f}}} ) \qquad ( 18 )$$

This potential V(t) reaches the threshold Vₜ and triggers an event on the V-synapse 222 at time t_{acc}¹=t_{end}¹−τ_{ƒ}·log(x).

A first event is triggered on the output neuron 220 because of the V-synapse 221 at time tₒᵤₜ¹=tₗₐₛₜ¹+2T_{syn}+Tₙₑᵤ=t_{end}¹+T_{syn}+Tₙₑᵤ. The second event triggered by the synapse 222 occurs at time tₒᵤₜ²=t_{acc}¹+Tₘᵢₙ+T_{syn}+Tₙₑᵤ=tₒᵤₜ¹+Tₘᵢₙ−τ_{ƒ}·log(x).

Finally, the two events delivered by the output neuron 220 are separated by a time interval

$$Δ {T}_{out} = {t}_{out}^{2} - {t}_{out}^{1} = {T}_{min} - {τ}_{f} \cdot log ( x ) = f ( - \frac{{τ}_{f}}{{T}_{cod}} \cdot log ( x ) ) .$$

The representation of a number proportional to the natural logarithm log(x) of the input value x is properly obtained at the output. Since 0<x≤1, the logarithm log(x) is a negative value.

If we call A the value

$$A = {e}^{- \frac{{T}_{cod}}{{τ}_{f}}} ,$$

the circuit 210 of FIG. 21 delivers the representation of log_{A}(x) when it receives the representation of a real number x such that A≤x≤1, where log_{A}(⋅) designates the base-A logarithm operation. If we consider that in the form (11), the time interval between the two events delivered by the output neuron 220 can exceed Tₘₐₓ, the circuit 210 delivers the representation of log_{A}(x) for any number x such that 0<x≤1.

D.2. Exponentiation

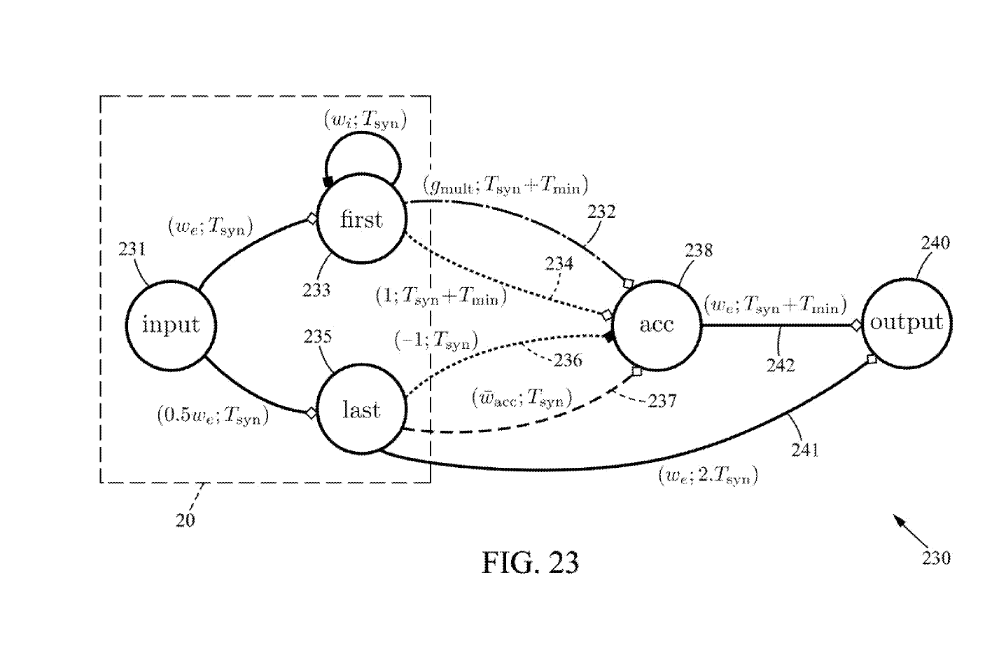

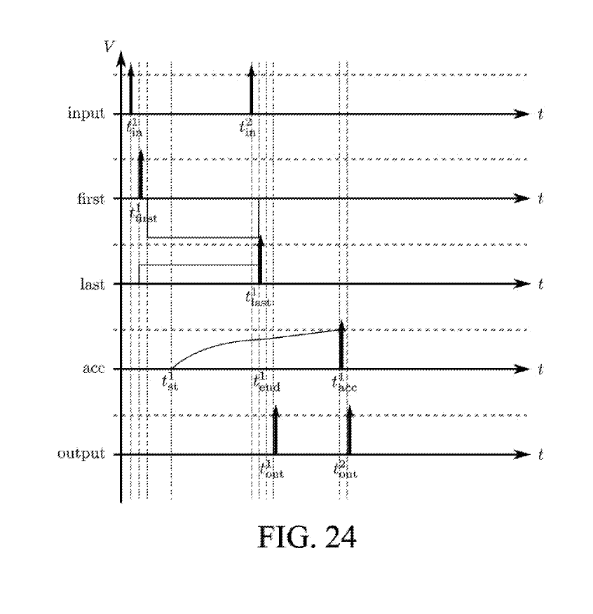

FIG. 23 shows a exponentiation circuit 230 for a number x∈[0, 1], an encoded representation of which is produced by an input neuron 231 in the form of two events occurring at times tᵢₙ¹ and tᵢₙ²=tᵢₙ¹+Δt (FIG. 24) with Δt=ƒ(x)=Tₘᵢₙ+x·T_{cod}.

The input neuron 231 belongs to a group of nodes 20 similar to that described in reference to FIG. 2. The first neuron 233 of this group 20 is the emitter node of a g_{ƒ}-synapse 232 having the weight gₘᵤₗₜ and a delay of Tₘᵢₙ+T_{syn}, as well as of an excitation gate-synapse 234 having a weight of 1 and a delay of Tₘᵢₙ+T_{syn}. The last neuron 235 of the group 20 is the emitter node of an inhibiting gate-synapse 236 having a weight of −1 and the delay T_{syn}, as well as of an excitation gₑ-synapse 237 having the weight w̅_{acc} and the delay T_{syn}. The synapses have the same acc neuron 238 as a receiver node.

The circuit 230 further comprises an output neuron 240 that is the receiver node of an excitation V-synapse 241 having the weight wₑ and a delay of 2·T_{syn} coming from the last neuron 235, and of an excitation V-synapse 242 having the weight wₑ and a delay of Tₘᵢₙ+T_{syn} coming from the acc neuron 238.

The operation of the exponentiation circuit 230 according to FIG. 23 is illustrated by FIG. 24.

The emission of the first spike at time tᵢₙ¹ at the input neuron 231 triggers an event at the output of the first neuron 233 at time t_{first}¹=tᵢₙ¹+T_{syn}+Tₙₑᵤ. The first neuron 233 starts an exponentially-growing accumulation in the acc neuron 238 at time tₛₜ¹=tᵢₙ¹+Tₘᵢₙ+2·T_{syn}+Tₙₑᵤ via the g_{ƒ}-synapse 232 and the gate-synapse 234.

The component g_{ƒ} of the acc neuron 238 changes according to:

$${g}_{f} ( t ) = {V}_{t} \cdot \frac{{τ}_{m}}{{τ}_{f}} \cdot {e}^{- \frac{t - {t}_{st}^{1}}{{τ}_{f}}} \qquad ( 19 )$$

and its membrane potential according to:

$$V ( t ) = {V}_{t} \cdot ( 1 - {e}^{- \frac{t - {t}_{st}^{1}}{{τ}_{f}}} ) \qquad ( 20 )$$

The emission of the second spike at time tᵢₙ²=tᵢₙ¹+Tₘᵢₙ+x·T_{cod} at the input neuron 231 causes the last neuron 235 to deliver an event at time tₗₐₛₜ¹=tᵢₙ²+T_{syn}+Tₙₑᵤ. This event transported by the gate-synapse 236 stops the exponentially-changing accumulation carried out by the acc neuron 238 at time t_{end}¹=tₗₐₛₜ¹+T_{syn}=tₛₜ¹+x·T_{cod}. At this time, the potential value Vₜ·(1−A^{x}) is stored in the acc neuron 238, where, as above,

$$A = {e}^{- \frac{{T}_{cod}}{{τ}_{f}}} .$$

Via the gₑ-synapse 237, the last neuron 235 further activates the linear dynamics having the weight w̅_{acc} on the acc neuron 238 at the same time t_{end}¹.

The membrane potential of the neuron 238 thus changes according to:

$$V ( t ) = {V}_{t} \cdot ( 1 - {A}^{x} + \frac{t - {t}_{end}^{1}}{{T}_{cod}} ) \qquad ( 21 )$$

This potential V(t) reaches the threshold Vₜ and triggers an event on the V-synapse 222 at time t_{acc}¹=t_{end}¹+A^{x}·T_{cod}.

A first event is triggered on the output neuron 240 because of the V-synapse 241 at time tₒᵤₜ¹=tₗₐₛₜ¹+2T_{syn}+Tₙₑᵤ=t_{end}¹+T_{syn}+Tₙₑᵤ. The second event triggered by the synapse 242 occurs at time tₒᵤₜ²=t_{acc}¹+Tₘᵢₙ+T_{syn}+Tₙₑᵤ=tₒᵤₜ¹+Tₘᵢₙ+A^{x}·T_{cod}.

Finally, the two events delivered by the output neuron 240 are separated by a time interval ΔTₒᵤₜ=tₒᵤₜ²−tₒᵤₜ¹=Tₘᵢₙ+A^{x}·T_{cod}=ƒ(A^{x}).

The circuit 230 of FIG. 23 thus delivers the representation of A^{x} when it receives the representation of a number x between 0 and 1. This circuit can accept input values x greater than 1 (Δt>Tₘₐₓ) and also deliver the representation of A^{x} on its output neuron 240.

The circuit 230 of FIG. 23 carries out the inversion of the operation carried out by the circuit 210 of FIG. 21.

This can be used to implement various non-linear calculations using simple operations between logarithm calculation and exponentiation circuits. For example, the sum of two logarithms allows multiplication to be carried out, the subtraction thereof allows division to be carried out, the sum of n times the logarithm allows a number x to be raised to a whole power n, etc.

D.3. Multiplication

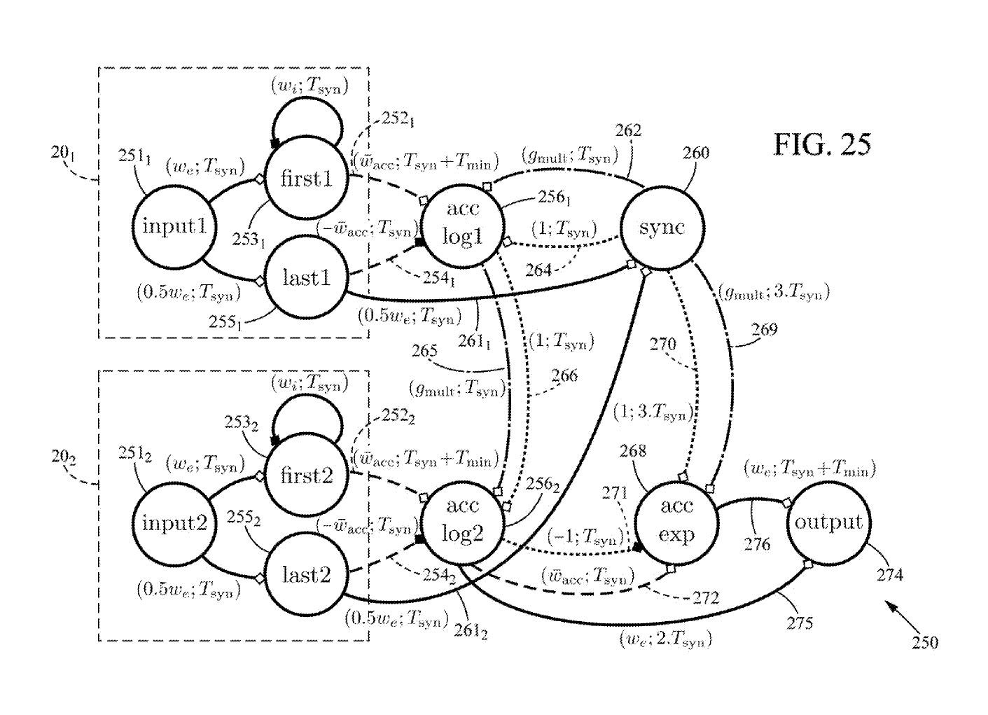

FIG. 25 shows a multiplier circuit 250 that calculates the product of two values x₁, x₂, the encoded representations of which are produced, respectively, by two input neurons 251₁, 251₂ in the form of two pairs of events occurring at times tᵢₙ₁¹ and tᵢₙ₁²=tᵢₙ₁¹+Δt₁ for the value x₁ and at times tᵢₙ₂¹ and tᵢₙ₂²=tᵢₙ₂¹+Δt₂ for the value x₂ (FIG. 25) with Δt₁=ƒ(x₁)=Tₘᵢₙ+x₁·T_{cod} and Δt₂=ƒ(x₂)=Tₘᵢₙ+x₂·T_{cod}.

Each input neuron 251ₖ (k=1 or 2) belongs to a group of nodes 20ₖ similar to that described in reference to FIG. 2. The first neuron 253ₖ of this group 20ₖ is the emitter node of an excitation gₑ-synapse 252ₖ having the weight w̅_{acc} and a delay of Tₘᵢₙ+T_{syn}, while the last neuron 255ₖ is the emitter node of an inhibiting gₑ-synapse 254ₖ having a weight of −w̅_{acc} and the delay T_{syn}. The two gₑ-synapses 252ₖ, 254ₖ from the group of nodes 20ₖ have, as a receiver node, the same acc neuron 256ₖ, which plays a role similar to the acc neuron 216 in FIG. 21.

The circuit 250 further comprises a sync neuron 260 that is the receiver node of two excitation V-synapses 261₁, 261₂ having a weight of wₑ/2 and the delay T_{syn} coming, respectively, from the last neurons 255₁, 255₂. A g_{ƒ}-synapse 262 having the weight gₘᵤₗₜ and the delay T_{syn} and an excitation gate-synapse 264 having a weight of 1 and the delay T_{syn} go from the sync neuron 260 to the acc neuron 256₁.

A g_{ƒ}-synapse 265 having the weight gₘᵤₗₜ and the delay T_{syn} and an excitation gate-synapse 266 having a weight of 1 and the delay T_{syn} go from the acc neuron 256₁ to the acc neuron 256₂.

The circuit 250 comprises another acc neuron 268 that plays a role similar to the acc neuron 238 in FIG. 23. The acc neuron 268 is the receiver node of a g_{ƒ}-synapse 269, having the weight gₘᵤₗₜ and a delay of 3T_{syn} and of an excitation gate-synapse 270, having a weight of 1 and a delay of 3 T_{syn}, both coming from the sync neuron 260. Moreover, the acc neuron 268 is the receiver node of an inhibiting gate-synapse 271, having a weight of −1 and the delay T_{syn}, and of an excitation gₑ-synapse 272, having the weight w̅_{acc} and the delay T_{syn}, both coming from the acc neuron 256₂.

Finally, the circuit 250 has an output neuron 274 that is the receiver node of an excitation V-synapse 275, having the weight wₑ and a delay of 2T_{syn}, coming from the acc neuron 256₂ and of an excitation V-synapse 276, having the weight wₑ and a delay of T_{syn}+T_{syn}, coming from the acc neuron 268.

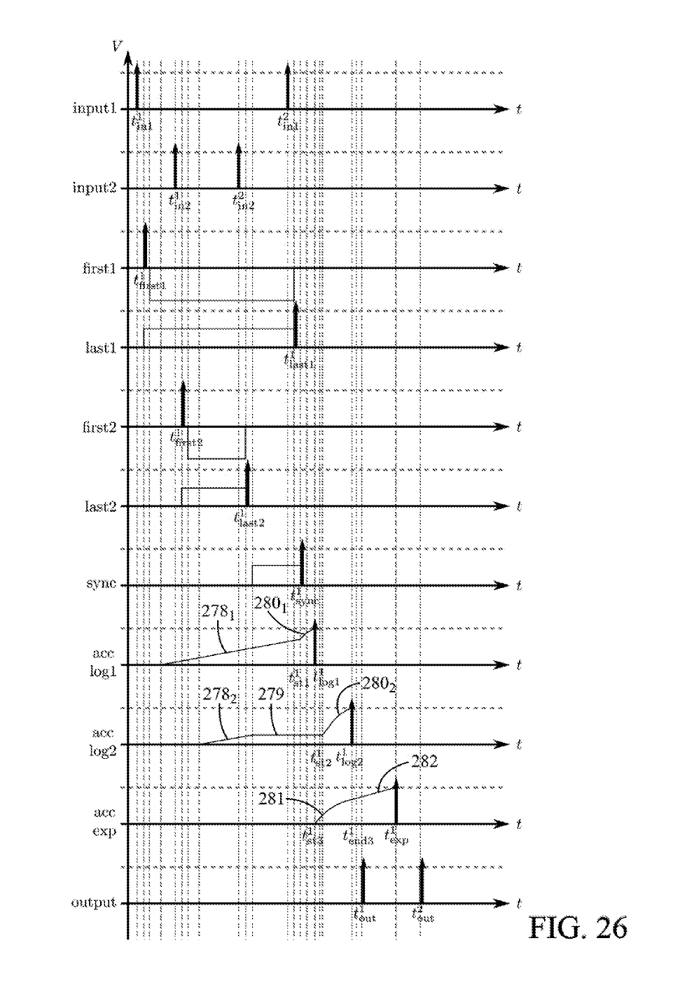

The operation of the multiplier circuit 250 according to FIG. 25 is illustrated by FIG. 26.

Each of the two acc neurons 256₁, 256₂ initially behaves like the acc neuron 216 of FIG. 21, with a linear progression 278₁, 278₂ having the weight w̅_{acc} on a first period having a respective duration of x₁·T_{cod}, x₂·T_{cod}, leading to storage of the potential values Vₜ·x₁ and Vₜ·x₂ in the acc neurons 256₁, 256₂.

Emission of the second spike at time tᵢₙ₂²=tᵢₙ₂¹+Tₘᵢₙ·x₂·T_{cod} at the input neuron having the smallest value (the input neuron 251₂ in the example shown in FIG. 26 where x₁>x₂) stops the linearly changing accumulation in the corresponding acc neuron 256₂ via the gₑ-synapse 254₂ at time tₗₐₛₜ₂¹+T_{syn}=tᵢₙ₂²+2T_{syn} 'Tₙₑᵤ. The membrane potential of this acc neuron 256₂ thus has a plateau 279 that lasts until its reactivation via the synapses 265, 266. At time tₗₐₛₜ₂¹+T_{syn}=tᵢₙ₂²+2T_{syn}+Tₙₑᵤ, the potential of the sync neuron 260 moves to the value Vₜ/2 because of the event received from the last neuron 255₂ via the V-synapse 261₂.

Emission of the second spike at time tᵢₙ₁²=tᵢₙ₁¹+Tₘᵢₙ+x₁·T_{cod} at the input neuron having the largest value (the input neuron 251₁ in the case of FIG. 26) stops the linearly-changing accumulation in the corresponding acc neuron 256₁ via the gₑ-synapse 254₁ at time tₗₐₛₜ₁¹+T_{syn}=tᵢₙ₁²+2T_{syn}+Tₙₑᵤ. At the same time, the potential of this sync neuron 260 reaches the value Vₜ because of the event received on the V-synapse 261₁. This results in emission of an event at time t_{sync}¹=tᵢₙ₁²+2T_{syn}+2Tₙₑᵤ on the synapses 262 and 264. The exponential change 280₁ is then activated in the acc neuron 256₁ instead of the linear change 278₁ at time tₛₜ₁¹=t_{sync}¹+T_{syn}. In parallel, the synapses 269, 270 activate the exponential change 281 in the acc neuron 268 at time tₛₜ₃¹=t_{sync}¹+3T_{syn}.

The potential of the acc neuron 256₁ reaches the value Vₜ and triggers an event on the synapses 265, 266 at time t_{log1}¹=tₛₜ₁¹−τ_{ƒ}·log(x₁).

The exponential change 280₁ is thus activated in the acc neuron 256₂ at time tₛₜ₂¹=t_{log1}¹+T_{syn}. The potential of this acc neuron 256₂ reaches the threshold Vₜ and triggers an event on the synapses 271, 272, 275 at time t_{log2}¹=tₛₜ₂¹−τ_{ƒ}·log(x₂)=t_{sync}¹−τ_{ƒ}·log(x₁·x₂)+2T_{syn}. The gate-synapse 271 deactivates the exponential change 281 in the acc neuron 268 at time t_{end3}¹=t_{log2}¹+T_{syn}, and simultaneously, the linear change 282 in the acc neuron 268 is activated via the gₑ-synapse 272, starting from the value:

$${V}_{t} \cdot ( 1 - {e}^{- \frac{{t}_{end 3}^{1} - {t}_{st 3}^{1}}{{τ}_{f}}} ) = {V}_{t} \cdot ( 1 - {x}_{1} \cdot {x}_{2} ) \qquad ( 22 )$$

The V-synapse 275 triggers the emission of a first spike on the output neuron 274 at time tₒᵤₜ¹=t_{log2}¹+2T_{syn}+Tₙₑᵤ.

The acc neuron 268 reaches the threshold Vₜ and triggers an event on the V-synapse 276 at time tₑₓₚ¹=t_{end3}¹ x₁·x₂·T_{cod}. This results in emission of a second spike at the output neuron 274 at time tₒᵤₜ²=tₑₓₚ¹+Tₘᵢₙ+T_{syn}+Tₙₑᵤ.

Finally, the two events delivered by the output neuron 268 are separated by a time interval ΔTₒᵤₜ=tₒᵤₜ²−tₒᵤₜ¹=Tₘᵢₙ+x₁·x₂·T_{cod}=ƒ(x₁·x₂)

The circuit 250 of FIG. 25 thus delivers, on its output neuron 268, the representation of the product x₁·x₂ of two numbers x₁, x₂ between A and 1, the respective representations of which it receives on its input neurons 251₁, 251₂.

For this, the pairs of events did not have to be received in a synchronised manner on the input neurons 251₁, 251₂ since the sync neuron 260 handles the synchronisation.

D.4. Signed Multiplication

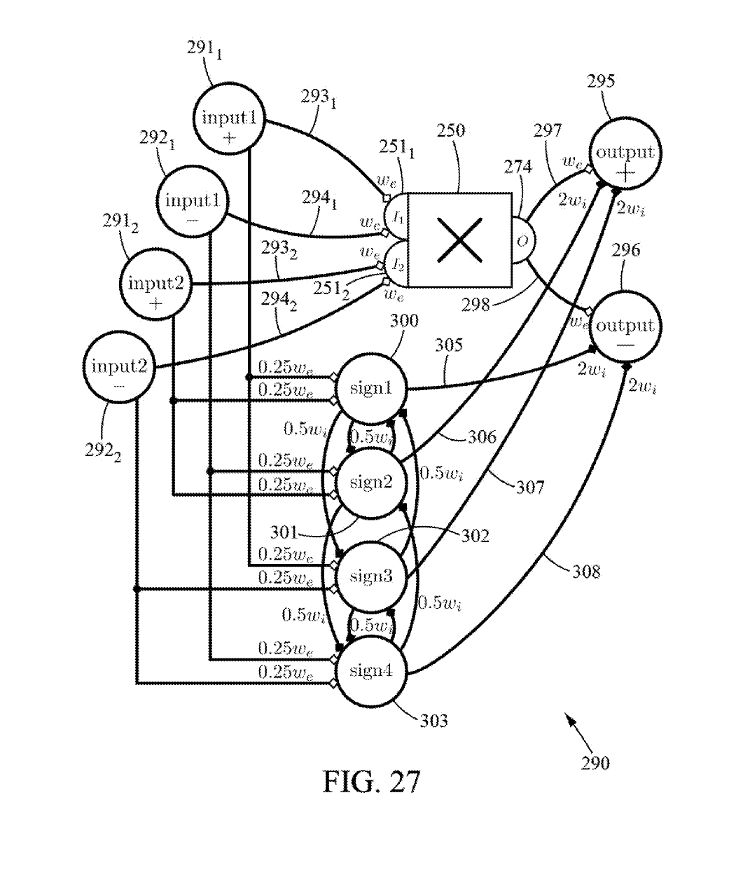

FIG. 27 shows a multiplier circuit 290 that calculates the product of two signed values x₁, x₂. All the synapses shown in FIG. 27 have the delay T_{syn}.

For each input value xₖ (1≤k≤2), the multiplier circuit 290 comprises a input+ neuron 291ₖ and a input− neuron 292ₖ that are the emitter nodes of two respective V-synapses 293ₖ and 294ₖ having the weight wₑ. The V-synapses 293₁ and 294₁ are directed towards an input neuron 251₁ of a multiplier circuit 250 of the type shown in FIG. 25, while the V-synapses 293₁ and 294₁ are directed towards the other input neuron 251₂ of the circuit 250.

The multiplier circuit 290 has a output+ neuron 295 and a output− neuron 296 that are the receiver nodes of two respective excitation V-synapses 297 and 298 having the weight wₑ coming from the output neuron 274 of the circuit 250.

The multiplier circuit 290 also comprises four sign neurons 300-303 connected to form logic for selecting the sign of the result of the multiplication. Each sign neuron 300-303 is the receiver node of two respective excitation V-synapses having a weight of wₑ/4 coming from two of the four input neurons 291ₖ, 292ₖ. The sign neuron 300 connected to the input+ neurons 291₁, 291₂ detects the reception of two positive inputs x₁, x₂. It forms the emitter node of an inhibiting V-synapse 305 having a weight of 214), going to the output− neuron 296. The sign neuron 303 connected to the input− neurons 292₁, 292₂ detects the reception of two negative inputs x₁, x₂. It forms the emitter node of an inhibiting V-synapse 308 having a weight of 2wᵢ going to the output− neuron 296. The sign neuron 301 connected to the input neuron 292₁ and the input+ neuron 292₁ detects the reception of a negative input x₁ and of a positive input x₂. It forms the emitter node of an inhibiting V-synapse 306 having a weight of 2wᵢ going to the output+ neuron 295. The sign neuron 302 connected to the input+ neuron 291₁ and the input− neuron 292₂ detects the reception of a positive input x₁ and of a negative input x₂. It forms the emitter node of an inhibiting V-synapse 307 having a weight of 2wᵢ going to the output+ neuron 295.

Inhibiting V-synapses are arranged between the sign neurons 300-303 in order to ensure that only one of them acts in order to inhibit one of the output+ neuron 295 and the output− neuron 296. Each sign neuron 300-303 corresponding to a sign (+ or −) of the product is thus the emitter node of two inhibiting V-synapses having a weight of wₑ/2 going, respectively, to the two sign neurons corresponding to the opposite sign.

Thus arranged, the circuit 290 of FIG. 27 delivers two events separated by the time interval ƒ(|x₁·x₂|) on one of its outputs 295, 296, according to the sign of x₁·x₂, when the two numbers x₁, x₂ are presented with their respective signs on the inputs 291ₖ, 292ₖ.

Logic for detecting a zero on one of the inputs can be added thereto, like in the case of FIG. 17, in order to make sure that an input of zero will produce the time interval Tₘᵢₙ between two events produced on the output+ neuron 295 and not the output− neuron 296.

### E. Solving Differential Equations

E.1. Integration

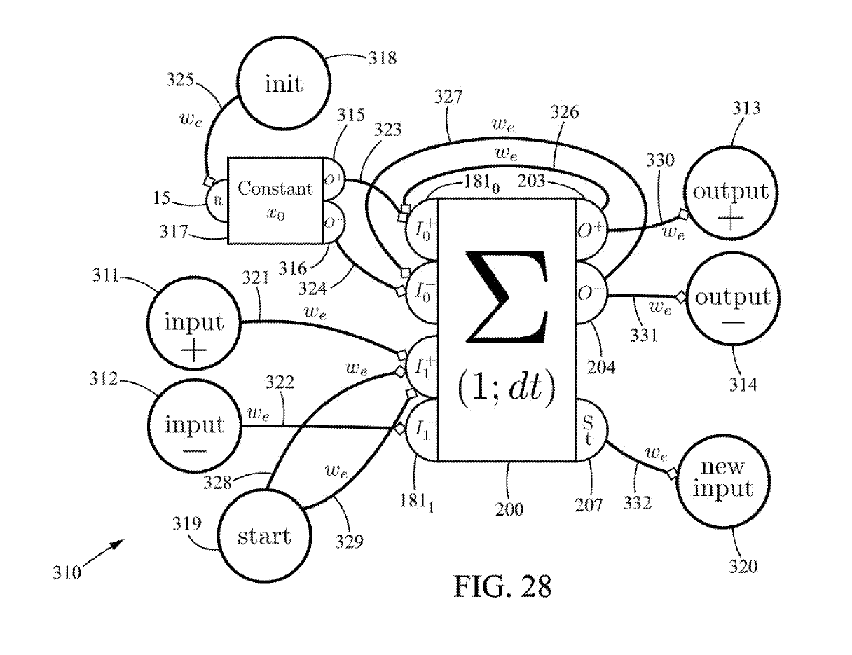

FIG. 28 shows a circuit 310 that reconstructs a signal from its derivatives provided in signed form on a neuron of a pair of input+ and input− neurons 311, 312. The integrated signal is presented, according to its sign, by a neuron of a pair of output+ and output− neurons 313, 314. The synapses 321-332 shown in FIG. 28 are all excitation V-synapses having the weight wₑ. They all have the delay T_{syn} except the synapse 329, the delay of which is Tₘᵢₙ+T_{syn}.

In order to carry out the integration, the circuit 310 uses a linear combination circuit 200 of the type shown in FIG. 20, with N=2 and coefficients α₀=1 and α₁=dt, where dt is the selected integration step size.

The input+ neuron 311 and the input neuron 312 are connected, respectively, to the input+ and input− neurons 181₁ of the circuit 200 that are associated with the coefficient α₁=dt, by two V-synapses 321, 322.

The other input+ and input− neurons 181₁ of the circuit 200, which are associated with the coefficient α₀=1, are connected, respectively, by two V-synapses 323, 324 to two output+ and output− neurons 315, 316 of a circuit 217, the role of which is to provide an initialisation value x₀ for the integration process. The circuit 317 substantially consists of a pair of output+ and output− neurons 315, 316 connected to the same recall neuron 15 in the manner shown in FIG. 1.

Another init neuron 318 of the integration circuit 310 is the emitter node of a synapse 325, the receiver node of which is the recall neuron 15 of the circuit 317. The init neuron 318 loads the integrator with its initial value x₀ stored in the circuit 317.

Synapses 326, 327 are arranged to provide feedback from the output+ neuron 143 of the linear combination circuit 200 to its input+ neuron 181₀ and from the output− neuron 144 of the integration circuit 200 to its input− neuron 181₀.

A start neuron 319 is the emitter node of two synapses 328, 329 that feed a zero value in the form of two events separated by the time interval Tₘᵢₙ on the input+ neuron 181₁ of the integration circuit 180.

The output+ neuron 143 and the output− neuron 144 of the linear combination circuit 200 are the respective emitter nodes of two synapses 330, 331, the receiver nodes of which are, respectively, the output+ neuron 313 and the output− neuron 314 of the integration circuit 310.

Finally, the integration circuit 310 has a new input neuron 320 that is the receiver node of a synapse 332 coming from the start neuron 207 of the linear combination circuit 200.

The initial value x₀ is, according to its sign, delivered on the output+ neuron 313 or the output− neuron 314 once the init neuron 318 and then the start neuron 319 have been activated. At the same time, an event is delivered by the new input neuron 320. This event signals, to the environment of the circuit 310, that the derivative value g′ (k·dt), with k=0, can be provided. As soon as this derivative value g′(k·dt) is presented on the input+ neuron 311 or the input− neuron 312, a new integral value is delivered by the output+ neuron 313 or the output− neuron 314 and a new event delivered by the new input neuron 320 signals, to the environment of the circuit 310, that the next derivative value g′ ((k+1)·dt) can be provided. This process is repeated as many times as derivative values g′ (k·dt) are provided (k=0, 1, 2, etc.).

After a (k+1)-th derivative value g′(k·dt) has been provided to the integrator circuit 310, the representation of the following value is found at the output:

x₀+Σᵢ₌₀^{k}g′(i·dt)·dt (23)

which, up to an additive constant, is an approximation of g(T)=∫₀^{T}g′(t)·dt with T=(k+1)·dt.

The circuits described above in reference to FIGS. 1-28 can be assembled and configured to execute numerous types of calculations in which the values manipulated, at the input and/or output are represented by time intervals between events received or delivered by neurons.

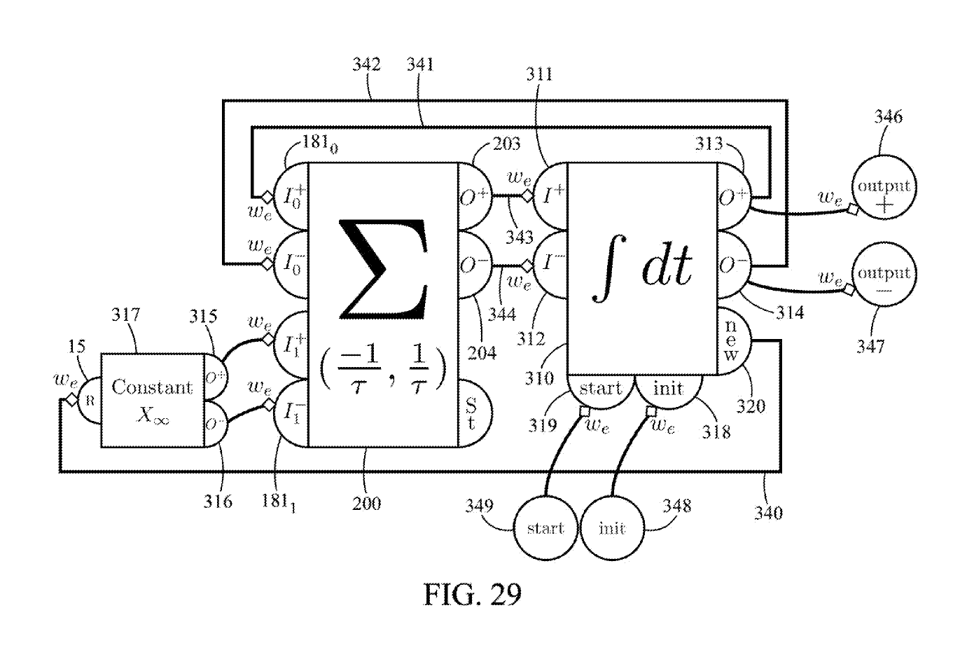

In particular, FIGS. 29, 31 and 33 illustrate examples of processing devices according to the invention used to solve differential equations. Calculations have been carried out with circuits built like in these figures, with parameters chosen, purely as an example, in the following manner: τₘ=100 s, τ_{ƒ}=20 ms, Vₜ=10 mV, Tₘᵢₙ=10 ms and T_{cod}=100 ms.

E.2. First-Order Differential Equation

FIG. 29 shows a processing device that implements the resolution of the differential equation:

$$τ \cdot \frac{dX}{dt} + X ( t ) = {X}_{∞} \qquad ( 24 )$$

where τ and X_{∞} are parameters that can take on various values. The synapses shown in FIG. 29 are all excitation V-synapses having the weight wₑ and the delay T_{syn}.

In order to solve equation (24), the device of FIG. 29 uses:
a linear combination circuit 200 as shown in FIG. 20, with N=2 and coefficients α₀=−1/τ and α₁=+1/τ;
an integrator circuit 310 as shown in FIG. 28, with an integration step size dt; and
a circuit 317 for providing the constant X_{∞}, similar to the circuit 317 described in reference to FIG. 28, in the form of the time interval ƒ(|X_{∞}|) between two spikes delivered either by its output+ neuron 315 or by its output− neuron 316, according to the sign of X_{∞}.

The constant X_{∞} is provided at one of the input+ and input− neurons 181₁ associated with the coefficient α₁=1/τ in the linear combination circuit 200 after each activation of the recall neuron 15 that is the receiver node of a synapse 340 coming from the new input neuron 320 of the integrator circuit 310. Two synapses 341, 342 provide feedback from the output node output+ 313 of the integrator circuit 310 to the other input node input+ 181₀ of the linear combination circuit 200, and from the output node output− 314 of the circuit 310 to the other input node input− 181₀ of the circuit 200. Two synapses 343, 344 go from the output node output+ 203 of the linear combination circuit 200 to the input node input+ 311 of the integrator circuit 310 and, respectively, from the output node output+ 204 of the circuit 200 to the input node input− 312 of the circuit 310.

The device of FIG. 29 has a pair of output+ and output− neurons 346, 347 that are the receiver nodes of two synapses coming from the output+ neuron 313 and the output− neuron 314 of the integrator circuit 310.

The init and start neurons 348, 349 allow the process of integration to be initialised and started. The init neuron 348 must be triggered before the integration process in order to load the initial value into the integrator circuit 310. The start neuron 349 is triggered in order to deliver the first value from the circuit 310.

The device of FIG. 29 is made using 118 neurons if the components as described in reference to the preceding figures are used. This number of neurons can be reduced via optimisation.

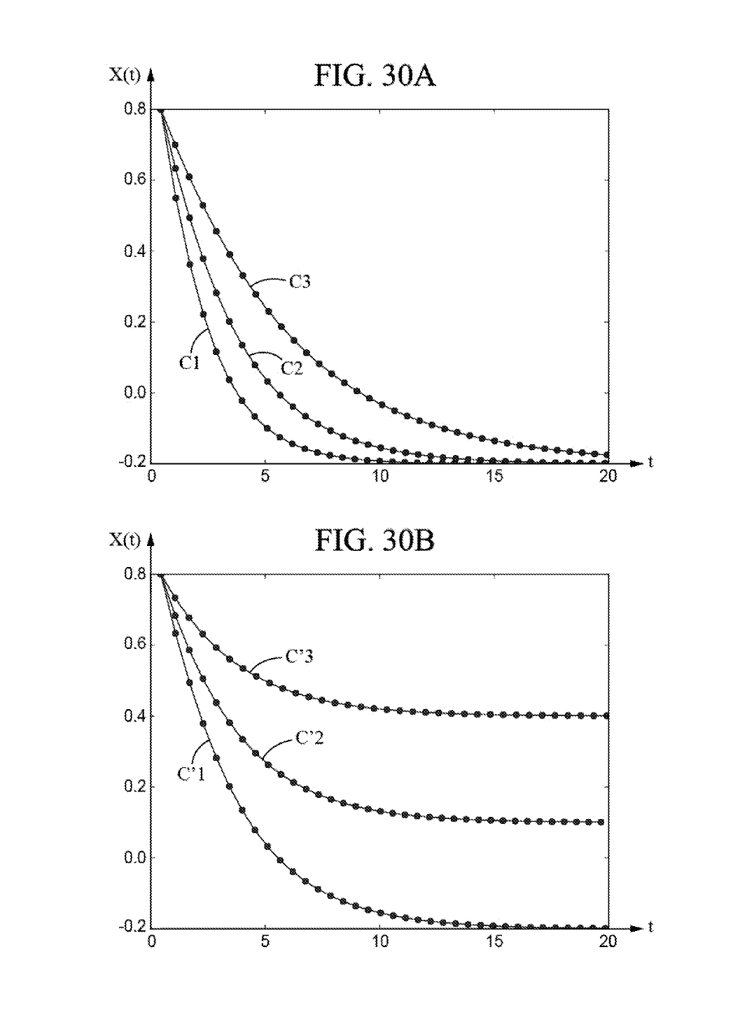

Results of simulation of this device with various sets of parameters τ, X_{∞} and with an integration step size dt=0.5 are presented in FIG. 30A for various values of τ and in FIG. 30B for various values of X_{∞} (X_{∞}=−0.2, X_{∞}=0.1 and X_{∞}=−0.4). Each point of the curves C1-C3, C′ 1-C′3 shown in FIGS. 30A and 30B corresponds to a respective output value encoded by a pair of spikes delivered by the output+ neuron 346 or the output− neuron 347. It is observed that the curves thus obtained for the solution X(t) of the differential equation (24) correspond to what is expected (via analytical resolution).

E.3. Second-Order Differential Equation

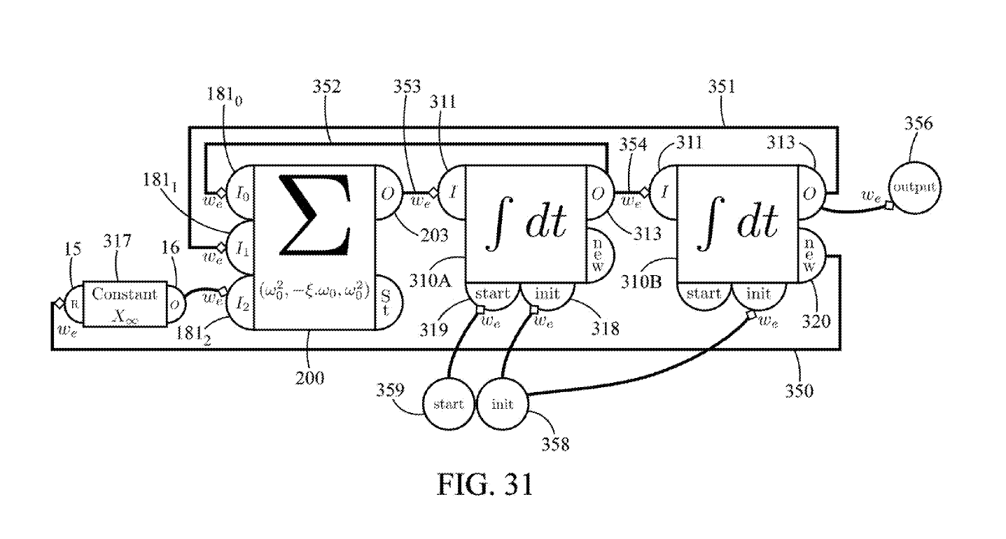

FIG. 31 shows a processing device that implements the resolution of the differential equation:

$$\frac{1}{{ω}_{0}^{2}} \cdot \frac{{d}^{2} X}{{dt}^{2}} + \frac{ξ}{{ω}_{0}} \cdot \frac{dX}{dt} + X ( t ) = {X}_{∞} \qquad ( 25 )$$

where ξ and ω₀ are parameters that can take on various values. The synapses shown in FIG. 31 are all excitation V-synapses having the weight wₑ and the delay T_{syn}. Since the values manipulated in this example are all positive, it is not necessary to provide two distinct paths for the positive values and for the negative values. Only the path relating to the positive values is therefore included.

In order to solve equation (25), the device of FIG. 31 uses:
a linear combination circuit 200 as shown in FIG. 20, with N=3 and coefficients α₀=α₂=ω₀² and α₁=−ξ·ω₀;
two integrator circuits 310A, 310B like the one shown in FIG. 28, with an integration step size dt; and
a circuit 317 for providing the constant X_{∞}, similar to the circuit described in reference to FIG. 1, in the form of the time interval ƒ(X_{∞}) between two spikes delivered by its output neuron 16 (X_{∞}>0).

The constant X_{∞} is provided at the input neuron 181₂ associated with the coefficient α₂=ω₀² in the linear combination circuit 200 after each activation of the recall neuron 15 that is the receiver node of a synapse 350 coming from the new input neuron 320 of the second integrator circuit 310B. Two synapses 351, 352 provide feedback from the output node output 313 of the second integrator circuit 310B to the input node input 181₁ of the linear combination circuit 200 associated with the coefficient α₁=−ξ·ω₀ and, respectively, from the output node output 313 of the first integrator circuit 310A to the other input node input 181₀, of the circuit 200, associated with the coefficient α₀=ω₀². A synapse 353 goes from the output node output 203 of the linear combination circuit 200 to the input node input 311 of the first integrator circuit 310A. A synapse 354 goes from the output node output 313 of the first integrator circuit 310A to the input node input 311 of the second integrator circuit 310B.

The device of FIG. 31 has an output neuron 356 that is the receiver node of a synapse coming from the output neuron 313 of the second integrator circuit 310B.

The init and start neurons 358 359 allow the process of integration to be initialised and started. The init neuron 358 must be triggered before the integration process in order to load the initial value into the integrator circuits 310A, 310B. The start neuron 359 is triggered in order to deliver the first value from the second integrator circuit 310B.

The device of FIG. 31 is made using 187 neurons if the components as described in reference to the preceding figures are used. This number of neurons can be reduced via optimisation.

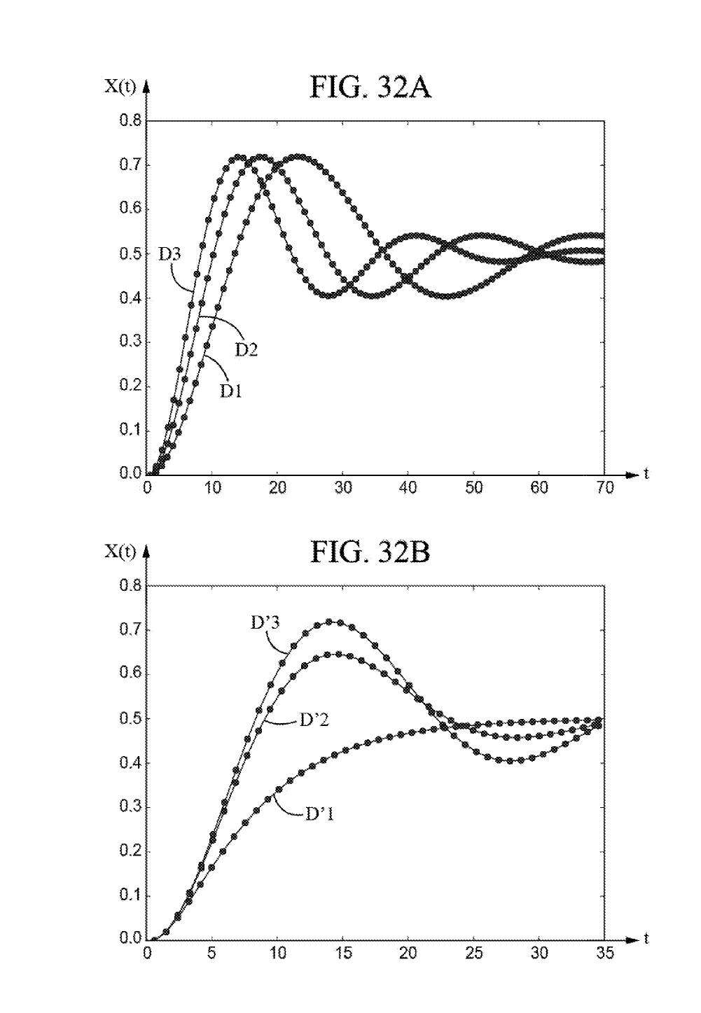

Results of simulation of this device with various sets of parameters ξ, ω₀ and with an integration step size dt=0.2 and X_{∞}=−0.5 are presented in FIG. 32A for various values of ω₀ and in FIG. 32B for various values of ξ. Each point on the curves D1-D3, D′1-D′3 shown in FIGS. 32A and 32B corresponds to a respective output value encoded by a pair of spikes delivered by the output neuron 356. It is clear that the curves thus obtained for the solution X(t) of the differential equation (25) again correspond to what is expected.

E.4. Resolution of a System of Non-Linear Differential Equations

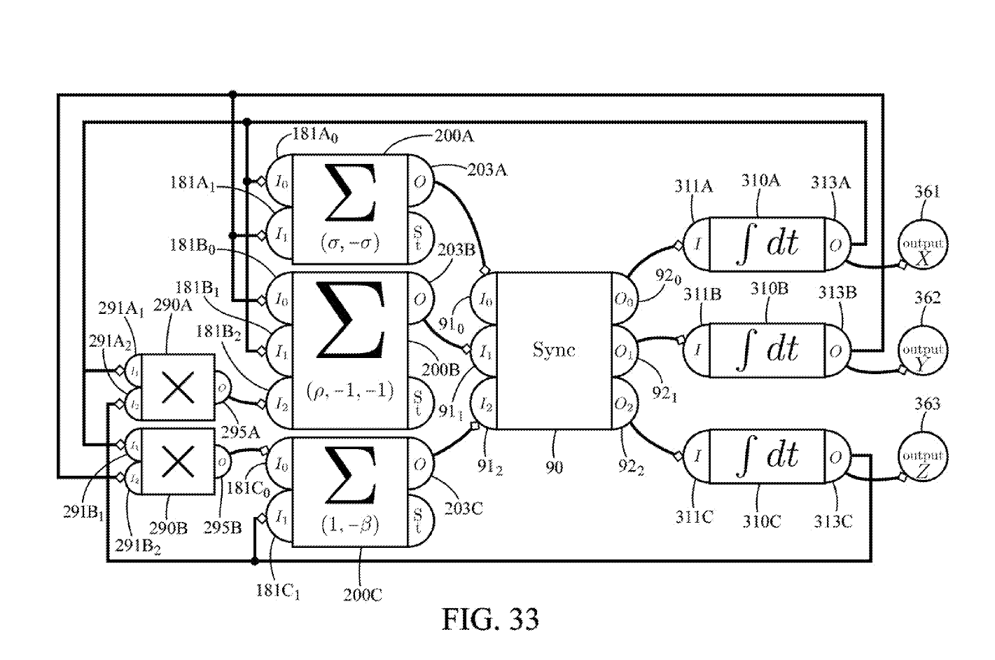

FIG. 33 shows a processing device that implements the resolution of the system of non-linear differential equations proposed by E. Lorenz for the modelling of a deterministic non-periodic flow (“Deterministic Nonperiodic Flow”, Journal of the Atmospheric Sciences, Vol. 20, No. 2, pages 130-141, March 1963):

$$\{ \begin{matrix}\frac{dX}{dt} = σ ( Y ( t ) - X ( t ) ) \\ \frac{dY}{dt} = ρ \cdot X ( t ) - Y ( t ) - X ( t ) \cdot Z ( t ) \\ \frac{dZ}{dt} = X ( t ) \cdot Y ( t ) - β \cdot Z ( t )\end{matrix} \qquad ( 26 )$$

In order to make sure that the system modelled has a chaotic behaviour, the device of FIG. 33 was simulated with the choice of parameters σ=10, β=8/3 and ρ=28. The variables were scaled in order to obtain state variables X, Y and Z each changing within the interval [0, 1] in such a way that they could be represented in the form (11) above. The initial state of the system was set to X=−0.15, Y=−0.20, and Z=0.20. The integration step size used was dt=0.01.

The synapses shown in FIG. 33 are all excitation V-synapses having the weight wₑ and the delay T_{syn}. In order to simplify the drawing, only one path is shown, but it should be understood that each time, there is a path for the positive values of the variables and, in parallel, a path for their negative values.

In order to solve the system (26), the device of FIG. 33 uses:
two signed multiplier circuits 290A, 290B like that shown in FIG. 27 in order to calculate the non-linearities contained in the derivatives of X, Y and Z;
three linear combination circuits 200A, 200B, 200C like that shown in FIG. 20 in order to calculate the derivatives of X, Y and Z;
a signed synchroniser circuit 90 of the type of that shown in FIG. 8 with N=3 in order to wait for the three derivatives to be calculated before changing the state of the system;
three integrator circuits 310A, 310B, 310C having a step size dt like that shown in FIG. 28 in order to calculate the new state from the derivatives X, Y and Z.

The linear combination circuit 200A is configured N=2 and coefficients α₀=σ and α₁=−σ. Its input neuron 181A₀ is excited from the output neuron 313A of the integrator circuit 310A, and its input neuron 181A₁ is excited from the output neuron 313B of the integrator circuit 310B. Its output neuron 203A is the emitter node of a synapse extending from the input neuron 91₀ to the synchroniser circuit 90.

The linear combination circuit 200B is configured N=3 and coefficients α₀=ρ and α₁=α₂=−1. Its input neuron 181B₀ is excited from the output neuron 313B of the integrator circuit 310B, its input neuron 181B₁ is excited from the output neuron 313A of the integrator circuit 310A, and its input neuron 181B₂ is excited from the output neuron 295A of the multiplier circuit 290A. Its output neuron 203B is the emitter node of a synapse coming from the input neuron 91₁ to the synchroniser circuit 90.

The linear combination circuit 200C is configured N=2 and coefficients α₀=1 and α₁=−β. Its input neuron 181C₀ is excited from the output neuron 295B of the multiplier circuit 290B, its input neuron 181C₁ is excited from the output neuron 313C of the integrator circuit 310C. Its output neuron 203C is the emitter node of a synapse extending from the input neuron 91₂ to the synchroniser circuit 90.

Three synapses go, respectively, from the output neuron 92₀ of the synchroniser circuit 90 to the input neuron 311A of the integrator circuit 310A, from the output neuron 92₁ of the circuit 90 to the input neuron 311B of the integrator circuit 310B, and from the output neuron 92₂ of the circuit 90 to the input neuron 311C of the integrator circuit 310C.

The input neuron 291A₁ of the multiplier circuit 290A is excited from the output neuron 313A of the integrator circuit 310A, and its input neuron 291A₂ is excited from the output neuron 313C of the integrator circuit 310C. The input neuron 291B₁ of the multiplier circuit 290B is excited from the output neuron 313A of the integrator circuit 310A, and its input neuron 291B₂ is excited from the output neuron 313B of the integrator circuit 310B.

The device of FIG. 33 has three output neurons 361, 362 and 363 that are the receiver nodes of three respective excitation V-synapses coming from the output neurons 313A, 313B and 313C of the integrator circuits 310A, 310B, 310C. These three output neurons 361-363 deliver pairs of events, the intervals of which represent values of the solution {X(t), Y(t), Z(t)} calculated for the system (26).

The device of FIG. 33 is made using 549 neurons if the components as described in reference to the preceding figures are used. This number of neurons can be significantly reduced via optimisation.

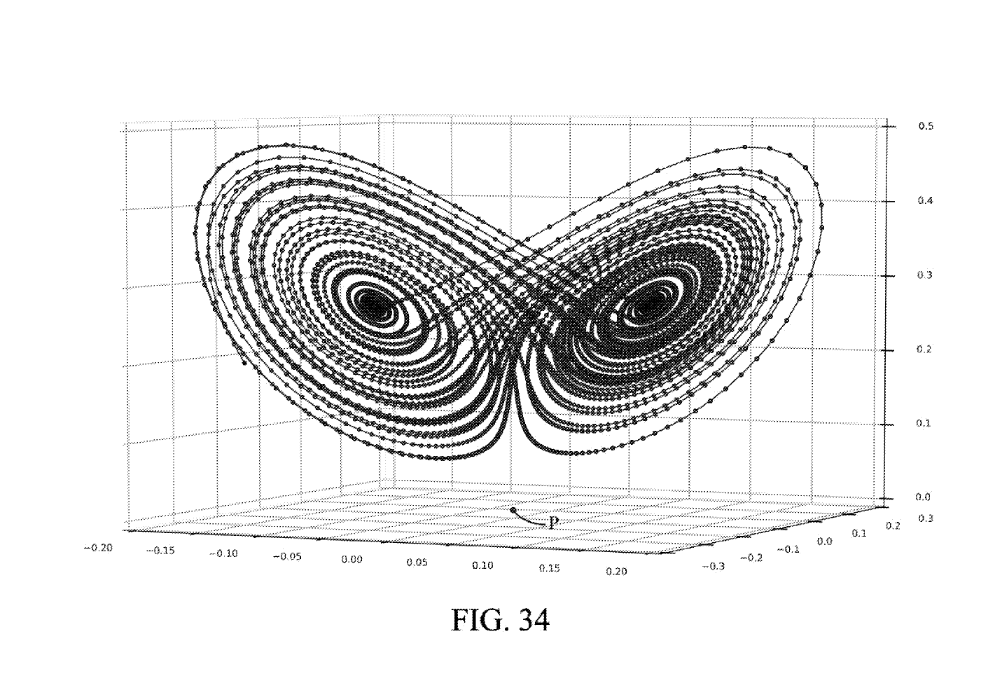

The points in FIG. 34 each correspond to a triplet {X(t), Y(t), Z(t)} of output values encoded by three pairs of spikes delivered by the three output neurons 361-363, respectively, in a three-dimensional graph illustrating a simulation of the device shown in FIG. 33. The point P represents the initialisation values X(0), Y(0), Z(0) of the simulation. The other points represent triplets calculated by the device of FIG. 33.

The system behaves in the expected manner, in accordance with the strange attractor described by Lorenz.

### F. Discussion

It has been shown that the calculation architecture proposed, with the representation of the data in the form of time intervals between events in a set of processing nodes, allows relatively simple circuits to be designed in order to carry out elementary functions in a very efficient and fast manner. In general, the results of the calculations are available as soon as the various input data have been provided (possible with a few synaptic delays).

These circuits can then be assembled to carry out more sophisticated calculations. They form a sort of brick from which powerful calculation structures can be built. Examples of this have been shown with respect to the resolution of differential equations.

When the elementary circuits are assembled, it is possible to optimise the number of neurons used. For example, some of the circuits were described with input neurons, and/or output neurons and/or first, last neurons. In practice, these neurons at the interfaces between elementary circuits can be eliminated without changing the functionality carried out.

The processing nodes are typically organised as a matrix. This lends itself well in particular to an implementation using FPGA.

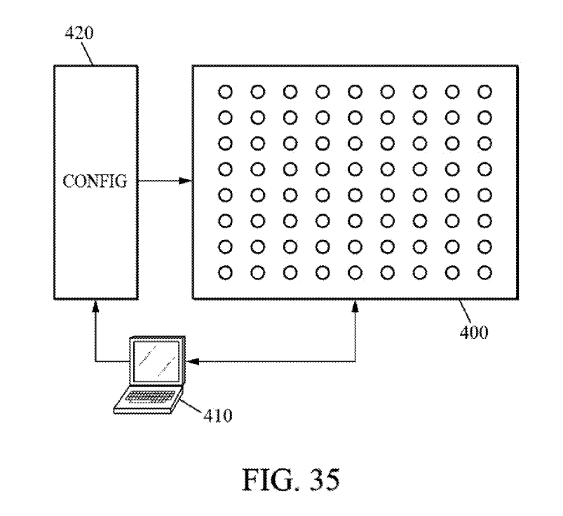

A programmable array 400 forming the set of processing nodes, or a portion of this set, in an exemplary implementation of the processing device is illustrated schematically in FIG. 35. The array 400 consists of multiple neurons all having the same model of behaviour according to the events received on their connections. For example, the behaviour can be modelled by the equations (1) indicated above, with identical parameters τₘ and τ_{ƒ} for the various nodes of the array.

Programming or configuration logic 420 is associated with the array 400 in order to adjust the synaptic weights and the delay parameters of the connections between the nodes of the array 400. This configuration is carried out in a manner analogous to that which is routinely practice in the field of artificial neural networks. In the present context, the configuration of the parameters of the connections is carried out according to the calculation program that will be executed and while taking into account the relationship used between the time intervals and the values that they represent, for example the relationship (11). If the program is broken up into elementary operations, the configuration can result from an assembly of circuits of the type of those that were described above. This configuration is produced under the control of a control unit 410 provided with a man-machine interface.

Another role of the control unit 410 and to provide the input values to the programmable array 400, in the form of events separated by suitable time intervals, in order for the processing nodes of the array 400 to execute the calculation and deliver the results. These results are quickly recovered by the control unit 410 in order to be presented to a user or to an application that uses them.

This calculation architecture is well suited for rapidly carrying out massively parallel calculations.

Moreover, it is relatively easy to have a pipelined organisation of the calculations, for the execution of algorithms that are well suited to this type of organisation.

The embodiments described above are illustrations of the present invention. Various modifications can be made to them without departing from the scope of the invention that emerges from the appended claims.

1. A data processing device, comprising a set of processing nodes and connections between the nodes,
wherein each connection has an emitter node and a receiver node out of the set of processing nodes and is configured to transmit, to the receiver node, events delivered by the emitter node,
wherein each node is arranged to vary a respective potential value-M according to events received by said node and to deliver an event when the potential value reaches a predefined threshold,
wherein at least one input value of the data processing device is represented by a time interval between two events received by at least one node,
and wherein at least one output value of the data processing device is represented by a time interval between two events delivered by at least one node.

2. The device of claim 1,
wherein each processing node is arranged to reset its potential value when delivering an event.

3. The device of claim 1,
wherein the connections between the nodes comprise potential variation connections, each having a respective weight,
and wherein the receiver node of a potential variation connection is arranged to respond to an event received on said potential variation connection by adding, to its potential value, the weight of said potential variation connection.

4. The device of claim 3,
wherein the set of processing nodes comprises at least one first node forming the receiver node of a first potential variation connection having a first positive weight at least equal to the predefined threshold for the potential value, and at least one second node forming the receiver node of a second potential variation connection having a weight at least equal to half the predefined threshold for the potential value and less than the predefined threshold for the potential value, wherein the first node further forms the emitter node and the receiver node of a third potential variation connection having a weight equal to the opposite of the first weight,
wherein the first node further forms the emitter node of a fourth connection and the second node further forms the emitter node of a fifth connection,
and wherein the first and second potential variation connections are configured to each receive two events separated by a first time interval representing an input value, whereby the fourth and fifth connections transport respective events having between them a second time interval related to the first time interval.

5. The device of claim 3, comprising at least one minimum calculation circuit,
wherein the minimum calculation circuit comprises:
first and second input nodes;
an output node;
first and second selection nodes;
first, second, third, fourth, fifth and sixth potential variation connections each having a first positive weight at least equal to half the predefined threshold for the potential value and less than the predefined threshold for the potential value;
seventh and eighth potential variation connections each having a second weight opposite to the first weight; and
ninth and tenth potential variation connections each having a third weight double of the second weight,
wherein the first input node forms the emitter node of the first and third connections and the receiver node of the tenth connection,
wherein the second input node forms the emitter node of the second and fourth connections and the receiver node of the ninth connection,
wherein the first selection node forms the emitter node of the fifth, seventh and ninth connections and the receiver node of the first and eighth connections,
wherein the second selection node forms the emitter node of the sixth, eighth and tenth connections and the receiver node of the second and seventh connections,
and wherein the output node forms the receiver node of the third, fourth, fifth and sixth connections.

6. The device of claim 3, comprising at least one maximum calculation circuit,
wherein the maximum calculation circuit comprises:
first and second input nodes;
an output node;
first and second selection nodes;
first, second, third and fourth potential variation connections each having a first positive weight at least equal to half the predefined threshold for the potential value and less than the predefined threshold for the potential value; and
fifth and sixth potential variation connections each having a second weight equal to double of the opposite of the first weight,
wherein the first input node forms the emitter node of the first and third connections,
wherein the second input node forms the emitter node of the second and fourth connections,
wherein the first selection node forms the emitter node of the fifth connection and the receiver node of the first and sixth connections,
wherein the second selection node forms the emitter node of the sixth connection and the receiver node of the second and fifth connections,
and wherein the output node forms the receiver node of the third and fourth connections.

7. The device of claim 3, comprising at least one subtractor circuit,
wherein the subtractor circuit comprises:
first and second synchronisation nodes;
first and second inhibition nodes;
first and second output nodes;
first, second, third, fourth, fifth and sixth potential variation connections each having a first positive weight at least equal to the predefined threshold for the potential value;
seventh and eighth potential variation connections each having a second weight equal to half the first weight;
ninth and tenth potential variation connections each having a third weight opposite to the first weight; and
eleventh and twelfth potential variation connections each having a fourth weight double the third weight,
wherein the first synchronisation node forms the emitter node of the first, second, third and ninth connections,
wherein the second synchronisation node forms the emitter node of the fourth, fifth, sixth and tenth connections,
wherein the first inhibition node forms the emitter node of the eleventh connection and the receiver node of the third, eighth and tenth connections,
wherein the second inhibition node forms the emitter node of the twelfth connection and the receiver node of the sixth, seventh and ninth connections,
wherein the first output node form the emitter node of the seventh connection and the receiver node of the first, fifth and eleventh connections,
wherein the second output node forms the emitter node of the eighth connection and the receiver node of the second, fourth and twelfth connections,
and wherein the first synchronisation node is configured to receive, on at least one potential variation connection having the second weight, a first pair of events having between them a first time interval representing a first operand, and the second synchronisation node is configured to receive, on at least one potential variation connection having the second weight, a second pair of events having between them a second time interval representing a second operand, whereby a third pair of events having between them a third time interval is delivered by the first output node if the first time interval is longer than the second time interval and by the second output node if the first time interval is shorter than the second time interval, the third time interval representing the absolute value of the difference between the first and second operand.

8. The device of claim 7,
wherein the subtractor circuit further comprises zero detection logic including at least one detection node associated with detection and inhibition connections with the first and second synchronisation node, one of the first and second inhibition node and one of the first and second output node,
and wherein the detection and inhibition connections are faster than the first, second, third, fourth, fifth, sixth, seventh, eighth, ninth, tenth, eleventh and twelfth connections, in order to inhibit the production of events by one of the first and second output node when the first and second time intervals are substantially equal.

9. The device of claim 3,
wherein the set of processing nodes comprises at least one node arranged to vary a current value according to events received on at least one current adjustment connection, and to vary its potential value over time at a rate proportional to said current value.

10. The device of claim 9,
wherein a processing node arranged to vary a current value is arranged to reset said current value to zero when it delivers an event.

11. The device of claim 9,
wherein the current value in at least one node has a component that is constant between two events received on at least one constant current component adjustment connection having a respective weight,
and wherein the receiver node of a constant current component adjustment connection is arranged to respond to an event received on said connection by adding the weight of said connection to the constant component of its current value.

12. The device of claim 11, comprising at least one inverter memory circuit,
wherein the inverter memory circuit comprises:
an accumulator node;
first, second and third constant current component adjustment connections, the first and third connections having a same positive weight and the second connection having a weight opposite to the weight of the first and third connections; and
at least one fourth connection,
wherein the accumulator node forms the receiver node of the first, second and third connections and the emitter node of the fourth connection,
and wherein the first and second connections are configured to respectively address to the accumulator node first and second events having between them a first time interval related to a time interval representing a value to be memorised, whereby the accumulator node then reacts to a third event received on the third connection by increasing its potential value until delivery of a fourth event on the fourth connection, the third and fourth events having between them a second time interval related to the first time interval.

13. The device of claim 12, comprising at least one memory circuit,
wherein the memory circuit comprises:
first and second accumulator nodes;
first, second, third and fourth constant current component adjustment connections, the first, second and fourth connections each having a first positive weight and the third connection having a weight opposite to the weight of the first, second and fourth connections; and
at least one fifth connection,
wherein the first accumulator node forms the receiver node of the first connection and the emitter node of the third connection,
wherein the second accumulator node forms the receiver node of the second, third and fourth and fifth connections and the emitter node of the fifth connection,
and wherein the first and second connections are configured to address, to the first and second accumulator nodes, respectively, first and second events having between them a first time interval related to a time interval representing a value to be memorised, whereby the second accumulator node then responds to a third event received on the fourth connection by increasing its potential value until delivery of a fourth event on the fifth connection, the third and fourth events having between them a second time interval related to the first time interval.

14. The device of claim 13,
wherein the memory circuit comprises a sixth connection having the first accumulator node as an emitter node, the sixth connection delivering an event to signal the availability of the memory circuit for reading.

15. The device of claim 14, comprising at least one synchronisation circuit, which includes a number N>1 of memory circuits and a synchronisation node,
wherein the synchronisation node is sensitive to each event delivered on the sixth connection of one of the N memory circuits via a respective potential variation connection having a weight equal to the first weight divided by N,
and wherein the synchronisation node is arranged to trigger simultaneous reception of the third events via the respective fourth connections of the N memory circuits.

16. The device of claim 11, comprising at least one accumulation circuit,
wherein the accumulation circuit comprises:
N inputs each having a respective weighting coefficient, N being a integer greater than 1;
an accumulator node;
a synchronisation node;
for each of the N inputs of the accumulation circuit:
a first constant current component adjustment connection having a first positive weight proportional to the respective weighting coefficient of said input; and
a second constant current component adjustment connection having a second weight opposite to the first weight; and
a third constant current component adjustment connection having a third positive weight,
wherein the accumulator node forms the receiver node of the first, second and third connections,
wherein the synchronization node forms the emitter node of the third connection,
wherein, for each of the N inputs, the first and second connections are configured to respectively address, to the accumulator node, first and second events having between them a first time interval representing a respective operand provided on said input,
wherein the synchronisation node is configured to deliver a third event once the first and second events have been addressed for each of the N inputs, whereby the accumulator node increases its potential value until delivery of a fourth event, the third and fourth event having between them a second time interval related to a time interval representing a weighted sum of the operands provided on the N inputs.

17. The device of claim 16,
wherein the accumulation circuit is part of a weighted addition circuit further comprising:
a second accumulator node;
a fourth constant current component adjustment connection having the third weight; and
a fifth and sixth connection,
wherein the synchronisation node of the accumulation circuit forms the emitter node of the fourth connection,
wherein the accumulator node of the accumulation circuit forms the emitter node of the fifth connection,
wherein the second accumulator node forms the receiver node of the fourth connection and the emitter node of the sixth connection,
wherein, in response to delivery of the third event by the synchronisation node, the accumulator node of the accumulation circuit increases its potential value until delivery of a fourth event on the fifth connection, and the second accumulator node increases its potential value until delivery of a fifth event on the sixth connection, the fourth and fifth events having between them a third time interval related to a time interval representing a weighted sum of the operands provided on the N inputs of the accumulation circuit.

18. The device of claim 16, comprising two accumulation circuits assembled in a linear combination circuit,
wherein the two accumulation circuits share their synchronisation node,
wherein the linear combination circuit further comprises a subtractor circuit configured to react to the third event delivered by the shared synchronisation node and to the fourth events respectively delivered by the accumulator nodes of the two accumulation circuits by delivering a pair of events having between them a third time interval representing the difference between the weighted sum for one of the two accumulation circuits and the weighted sum for the other of the two accumulation circuits.

19. The device of claim 11,
wherein the current value in at least one node has a component that decreases exponentially between two events received on at least one exponentially decreasing current component adjustment connection having a respective weight,
and wherein the receiver node of an exponentially decreasing current component adjustment connection is arranged to respond to an event received on said connection by adding the weight of said connection to the exponentially decreasing component of its current value.

20. The device of claim 19, comprising at least one logarithm calculation circuit,
wherein the logarithm calculation circuit comprises:
an accumulator node;
a first and a second constant current component adjustment connections, the first connection having a positive weight, and the second connection having a weight opposite to the weight of the first connection;
a third exponentially decreasing current component adjustment connection; and
at least one fourth connection,
wherein the accumulator node forms the receiver node of the first, second and third connections and the emitter node of the fourth connection,
wherein the first and second connections are configured to address, to the accumulator node, respective first and second events having between them a first time interval related to a time interval representing an input value of the logarithm calculation circuit,
wherein the third connection is configured to address, to the accumulator node, a third event simultaneous or posterior to the second event, whereby the accumulator node increases its potential value until delivery of a fourth event on the fourth connection, the third and fourth events having between them a second time interval related to a time interval representing a logarithm of said input value.

21. The device of claim 19,
wherein at least one node taking into account an exponentially decreasing current component is the receiver node of a deactivation connection in order to receive events for deactivation of the exponentially decreasing component.

22. The device of claim 21, comprising at least one exponentiation circuit,
wherein the exponentiation circuit comprises:
an accumulator node;
a first exponentially decreasing current component adjustment connection;
a second deactivation connection;
a third constant current component adjustment connection; and
at least one fourth connection,
wherein the accumulator node forms the receiver node of the first, second and third connections and the emitter node of the fourth connection,
wherein the first and second connections are configured to address, to the accumulator node, respective first and second event having between them a first time interval related to a time interval representing an input value of the exponentiation circuit,
wherein the third connection is configured to address, to the accumulator node, a third event simultaneous or posterior to the second event, whereby the accumulator node increases its potential value until delivery of a fourth event on the fourth connection, the third and fourth events having between them a second time interval related to a time interval representing an exponentiation of said input value.

23. The device of claim 21, comprising at least one multiplier circuit,
wherein the multiplier circuit comprises:
first, second and third accumulator nodes;
a synchronisation node;
first, second, third, fourth and fifth constant current component adjustment connections, the first, third and fifth connections having a first positive weight, and the second and fourth connections having a second weight opposite to the first weight;
sixth, seventh and eighth exponentially decreasing current component adjustment connections;
a ninth deactivation connection; and
at least one tenth connection,
wherein the first accumulator node forms the receiver node of the first, second and sixth connections and the emitter node of the seventh connection,
wherein the second accumulator node forms the receiver node of the third, fourth and seventh connections and the emitter node of the fifth and ninth connections,
wherein the third accumulator node forms the receiver node of the fifth, eighth and ninth connections and the emitter node of the tenth connection,
wherein the synchronisation node forms the emitter node of the sixth and eighth connections,
wherein the first and second connections are configured to address, to the first accumulator node, respective first and second event having between them a first time interval related to a time interval representing a first operand of the multiplier circuit,
wherein the third and fourth connections are configured to address, to the second accumulator node, respective third and fourth events having between them a second time interval related to a time interval representing a second operand of the multiplier circuit,
wherein the synchronisation node is configured to deliver a fifth event on the sixth and eighth connections once the first, second, third and fourth events have been received, whereby:
the first accumulator node increases its potential value until delivery of a sixth event on the seventh connection;
in response to the sixth event, the second accumulator node increases its potential value until delivery of a seventh event on the fifth and ninth connections;
in response to the seventh event, the third accumulator node increases its potential value until delivery of an eighth event on the tenth connection, the seventh and eighth events having between them a third time interval related to a time interval representing the product of the first and second operands.

24. The device of claim 23, further comprising sign detection logic associated with the multiplier circuit in order to detect respective signs of the first and second operand and cause two events having between them a time interval representing the product of the first and second operands to be delivered on one or the other of two outputs of the multiplier circuit according to the detected signs.

25. The device of claim 1,
wherein each connection is associated with a delay parameter, in order to signal the receiver node of said connection to carry out a change of state with a delay, with respect to reception of an event on the connection, indicated by said parameter.

26. The device of claim 1,
wherein the time interval Δt between two events representing a value having an absolute value x is in the form Δt=Tₘᵢₙ+x·T_{cod}, where Tₘᵢₙ and T_{cod} are predefined time parameters.

27. The device of claim 26,
wherein the values represented by time intervals have absolute values x between 0 and 1.

28. The device of claim 1, comprising, for an input value:
a first input comprising one node or two nodes out of the set of processing nodes, the first input being arranged to receive two events having between them a time interval representing a positive value of said input value; and
a second input comprising one node or two nodes out of the set of processing nodes, the second input being arranged to receive two events having between them a time interval representing a negative value of said input value.

29. The device of claim 1, comprising, for an output value:
a first output comprising one node or two nodes out of the set of processing nodes, the first output being arranged to deliver two events having between them a time interval representing a positive value of said output value; and
a second output comprising one node or two nodes out of the set of processing nodes, the second output being arranged to deliver two events having between them a time interval representing a negative value of said output value.

30. The device of claim 1,
wherein the set of processing nodes is in the form of at least one programmable array, the nodes of the array having a shared behavior model according to the events received, the device further comprising a programming logic in order to adjust weights and delay parameters of the connections between the nodes of the array according to a calculation program, and a control unit in order to provide input values to the array and recover output values calculated according to the program.
